(19) United States
(12) Patent Application Publication
(10) Pub. No.: US 2014/0197049 A1
(43) Pub. Date: Jul. 17, 2014

(54) SUPPORT FROM LEG OF USER FOR ELECTRONIC DEVICE OR TABLET COMPUTER AND METHOD

(71) Applicant: Belkin International, Inc., Playa Vista, CA (US)

(72) Inventors: Erin Napolitano, Los Angeles, CA (US); Barry Sween, Santa Monica, CA (US); Gary Lo, Kowloon, Hong Kong (CN); David Kleeman, Marina del Rey, CA (US); Xin Fu, Guangdong (CN)

(73) Assignee: Belkin International, Inc., Playa Vista, CA (US)

(21) Appl. No.: 14/211,995

(22) Filed: Mar. 14, 2014

Related U.S. Application Data
(63) Continuation-in-part of application No. 14/184,408, filed on Feb. 19, 2014.
Application No. 14/184,408 is a continuation of application No. 13/568,040, filed on Aug. 6, 2012, now Pat. No. 8,684,174.
Application No. 13/568,040 is a continuation of application No. 12/782,592, filed on May 18, 2010, now Pat. No. 8,235,208.
Application No. 12/782,592 is a continuation of application No. 11/810,823, filed on Jun. 6, 2007, now Pat. No. 7,735,644.
(60) Provisional application No. 61/799,277, filed on Mar. 15, 2013.

(51) Int. Cl. G06F 1/16

(52) U.S. Cl. CPC G06F 1/1613
USPC 206/45.24; 29/428

(57) ABSTRACT

An apparatus for supporting an electronic device such as a tablet computer from a user's leg, the apparatus having a leg-conforming region having a rounded edge configured to conform around the top of one of the user's legs. Various embodiments have a base, a lower back member, an upper back member, hinges, a flexible top layer, a flexible bottom layer, a central stiff layer, or a combination thereof. In some embodiments, the leg conforming region extends across a hinge. In certain embodiments, the members, base, or a combination thereof, are planar, rectangular, or both. In different embodiments, the leg conforming region can be flexible, elastic, or a hole through the apparatus. Hinges can be parallel, some embodiments include a handle, and methods include a method of obtaining, providing, or manufacturing an apparatus for supporting an electronic device from a user's leg.

### RELATED PATENT APPLICATIONS

This patent application is a non-provisional patent application of U.S. Provisional Patent Application No. 61/799,277, filed Mar. 15, 2013, which is incorporated herein by reference. This patent application is also a continuation-in-part patent application of U.S. patent application Ser. No. 14/184,408, filed Feb. 19, 2014, which is a continuation patent application of U.S. patent application Ser. No. 13/568,040, filed Aug. 6, 2012, which is a continuation of U.S. patent application Ser. No. 12/782,592, filed May 18, 2010, which is a continuation application of U.S. patent application Ser. No. 11/810,823, now U.S. Pat. No. 7,735,644, filed Jun. 6, 2007.

### FIELD OF THE INVENTION

This invention relates generally to supports and cases for electrical devices, and relates more particularly to such supports and cases that are configured for supporting electrical devices from one user's leg and methods concerning same.

### BACKGROUND OF THE INVENTION

Advancing technology has made portable electrical devices increasingly popular and has given such electrical devices an ever-increasing array of capabilities. Some electrical devices, such as digital music and video players, cellular phones, personal digital assistants, handheld digital computers, tablet computers, and the like, include the capability to display images or videos. While it is possible to view the images or videos while holding such video-capable devices in one's hand, it would often be more convenient and more comfortable to set down such electrical devices and have them maintain a position in which the images and videos can be viewed easily.

Furthermore, most portable electrical devices include display or touch screens and/or control mechanisms. It would be convenient for the user of such electrical devices if a support or case allowed easy viewing of the display screen and operation of the electrical device, without requiring the user to hold the electrical device or remove it from the case.

Accordingly, a need or potential for benefit exists for a support or case for an electrical device that allows it to maintain a hands-free operating and viewing position.

### BRIEF DESCRIPTION OF THE DRAWINGS

The invention will be better understood from a reading of the following detailed description of examples of embodiments, taken in conjunction with the accompanying figures in the drawings in which:

FIG. 1 illustrates a bottom, side isometric view of a case in a first embodiment of an open configuration and enclosing an electrical device, according to a first embodiment of the case;

FIG. 2 illustrates a top, front, side isometric view of the case of FIG. 1 in a second embodiment of an open configuration, according to the first embodiment of the case;

FIG. 3 illustrates a top, back, side isometric view of the case of FIG. 1 in a third embodiment of an open configuration, according to the first embodiment of the case;

FIG. 4 illustrates a side view of the case of FIG. 1 in a closed configuration and enclosing the electrical device of FIG. 1, according to the first embodiment of the case;

FIG. 5 illustrates another top, front, side isometric view of the case of FIG. 1 in a fourth embodiment of an open configuration and enclosing the electrical device of FIG. 1, according to the first embodiment of the case;

FIG. 6 illustrates a cross-sectional view along line I-I of FIG. 2 of the case of FIG. 1 in the second embodiment of an open configuration, according to the first embodiment of the case;

FIG. 7 illustrates a side view of a case in an open configuration and enclosing an electrical device, according to a second embodiment of the case;

FIG. 8 illustrates a top, front, side isometric view of a case in a first embodiment of an open configuration and enclosing an electrical device, according to a third embodiment of the case;

FIG. 9 illustrates a top, back, side isometric view of the case of FIG. 8 in a second embodiment of an open configuration, according to the third embodiment of the case;

FIG. 10 illustrates bottom, side isometric view of the case of FIG. 8 in a third embodiment of an open configuration, according to the third embodiment of the case;

FIG. 11 illustrates a flow chart for an embodiment of a method of using a case with an electrical device;

FIG. 12 is a perspective right-side front view of an example of an apparatus for supporting an electronic device from a user's leg, the apparatus shown supporting a tablet computer and being set up in a viewing configuration on a horizontal surface such as a desk or table;

FIG. 13 is a perspective right-side rear view of the apparatus for supporting an electronic device from a user's leg of FIG. 12, the apparatus shown supporting a tablet computer and being set up in a viewing configuration on a horizontal surface such as a desk or table;

FIG. 14 is a perspective left-side front view of the apparatus for supporting an electronic device from a user's leg of FIGS. 12 and 13, the apparatus shown supporting a tablet computer and being set up in a viewing configuration on a user's leg;

FIG. 15 is a perspective right-side bottom view of the apparatus for supporting an electronic device from a user's leg of FIGS. 12 to 14, the apparatus shown containing a tablet computer in a closed configuration on a horizontal surface such as a desk or table;

FIG. 16 is a perspective side view of the apparatus for supporting an electronic device from a user's leg of FIGS. 12 to 15, the apparatus shown supporting a tablet computer in a typing configuration on a horizontal surface such as a desk or table;

FIG. 17 is a perspective side view of the apparatus for supporting an electronic device from a user's leg of FIGS. 12 to 16, the apparatus shown supporting a tablet computer in a typing configuration on a user's leg;

FIG. 18 is a perspective front view of an example of an apparatus for supporting an electronic device from a user's leg, the apparatus shown without a tablet computer or other electronic device and being set up in a viewing configuration on a user's leg;

FIG. 19 is a top view of an apparatus for supporting an electronic device from a user's leg, the apparatus shown in a fully unfolded planar configuration; and

FIG. 20 is a top view of an apparatus for supporting an electronic device from a user's leg, the apparatus shown in a fully unfolded planar configuration.

For simplicity and clarity of illustration, the drawing figures illustrate the general manner of construction, and descriptions and details of well-known features and techniques may be omitted to avoid unnecessarily obscuring the invention. Additionally, the same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” and “have,” and any variations thereof, are intended to cover a non-exclusive inclusion, such that a process, method, system, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical, physical, mechanical, or other manner. The term “on,” as used herein, is defined as on, at, or otherwise adjacent to or next to or over.

### DETAILED DESCRIPTION OF EXAMPLES OF EMBODIMENTS

Various embodiments provide an apparatus for supporting a tablet computer from a user's leg that includes a substantially planar base, a substantially planar lower back member, a first hinge attaching the lower back member to the base, an upper back member, a second hinge attaching the upper back member to the lower back member, and a leg-conforming region having a rounded edge configured to conform around the top of one of the user's legs. In some embodiments, the upper back member is substantially planar. Further, in particular embodiments, when the first hinge and the second hinge are unfolded so that the apparatus is laid flat, the apparatus is substantially planar. Even further, in some embodiments, the base includes at least a first part of the rounded edge. Further still, in some embodiments, the lower back member includes at least a second part of the rounded edge. Even further still, in some embodiments, the leg-conforming region extends across the first hinge from the base to the lower back member.

In a number of embodiments, apparatus includes a flexible top layer, a flexible bottom layer, and a stiff layer located between the top layer and the bottom layer. Moreover, in particular embodiments, the top layer and the bottom layer extend from the base to the upper back member through the lower back member, and the stiff layer is broken at the first hinge and at the second hinge to allow bending of the apparatus at the first hinge and at the second hinge. Furthermore, in certain embodiments, the rounded edge is formed within the stiff layer.

In different embodiments, the leg-conforming region includes a flexible material, an elastic material, or a hole through the apparatus without any material. Further, in some embodiments, the leg-conforming region includes a center and the first hinge extends through the center of the leg-conforming region. Even further, in some embodiments, the second hinge is parallel to the first hinge. Further still, some embodiments include a third hinge, for example, extending through the base. In certain embodiments, for instance, the third hinge is substantially parallel to the first hinge and to the second hinge. Even further still, in a number of embodiments, without considering the leg-conforming region, the base is rectangular, the lower back member is rectangular, the upper back member is rectangular, when the first hinge and the second hinge are unfolded so that the apparatus is laid flat, the apparatus is rectangular, or a combination thereof. Moreover, in particular embodiments, when the first hinge and the second hinge are unfolded so that the apparatus is laid flat, the apparatus has rounded corners. Furthermore, in certain embodiments, the apparatus further includes a hand strap.

Still other embodiments include an apparatus for supporting an electronic device from a user's leg, the apparatus including: a flexible top layer, a flexible bottom layer, a stiff layer located between the top layer and the bottom layer, at least one hinge, wherein the stiff layer is broken at the hinge to allow bending of the apparatus at the hinge, and a leg-conforming region having a rounded edge configured to conform around the top of the user's leg, wherein the rounded edge is formed within the stiff layer. In a number of embodiments, the leg-conforming region extends across the hinge of the apparatus.

Yet other embodiments include a method of obtaining, providing, or manufacturing an apparatus for supporting an electronic device from a user's leg. Such a method can include, for example, at least the acts of: obtaining, providing, or manufacturing a base, obtaining, providing, or manufacturing a lower back member, obtaining, providing, or manufacturing a first hinge attaching the lower back member to the base, and obtaining, providing, or manufacturing a leg-conforming region having a rounded edge configured to conform around the top of one of the user's legs, wherein the leg-conforming region extends across the first hinge from the base to the lower back member.

In a number of embodiments, a case for an electrical device can include: (a) a first portion with a bottom surface; (b) a second portion adjacent to the first portion; (c) a third portion adjacent to the second portion; (d) a fourth portion adjacent to the third portion; and (e) a fifth portion with an interior surface and adjacent to the fourth portion. In this embodiment, at least one of the first portion or the third portion is configured to be removably coupled to the electrical device. Additionally, when the case is placed in an open configuration, the first portion is capable of being located over the fifth portion with the bottom surface of the first portion adjacent to the interior surface of the fifth portion.

In other embodiments, a holder for an electrical device can include: (a) an inner section with a bottom surface; (b) a first outer section adjacent to the inner section; (c) a second outer section with a first surface and adjacent to the first outer section; and (d) one or more ribs adjacent to the first surface of the second outer section. In these embodiments, the holder is configured to be removably coupled to the electrical device. Furthermore, the holder is configured to be placed in a position such that the inner section forming a substantially non-zero angle with the second outer section and the bottom surface of the inner section is at least partially supported by the first surface of the second outer section and one rib of the one or more ribs.

In yet another embodiment, a method of using a case with an electrical device includes: (a) providing the case to comprise: (1) a first portion with a bottom surface; (2) a second portion adjacent to the first portion; (3) a third portion adjacent to the second portion; (4) a fourth portion adjacent to the third portion; and (5) a fifth portion with an interior surface adjacent to the fourth portion; (b) coupling the electrical device to the case at the first portion; (c) placing the case in an open configuration with the bottom surface of the first portion over and adjacent to the interior surface of the fifth portion.

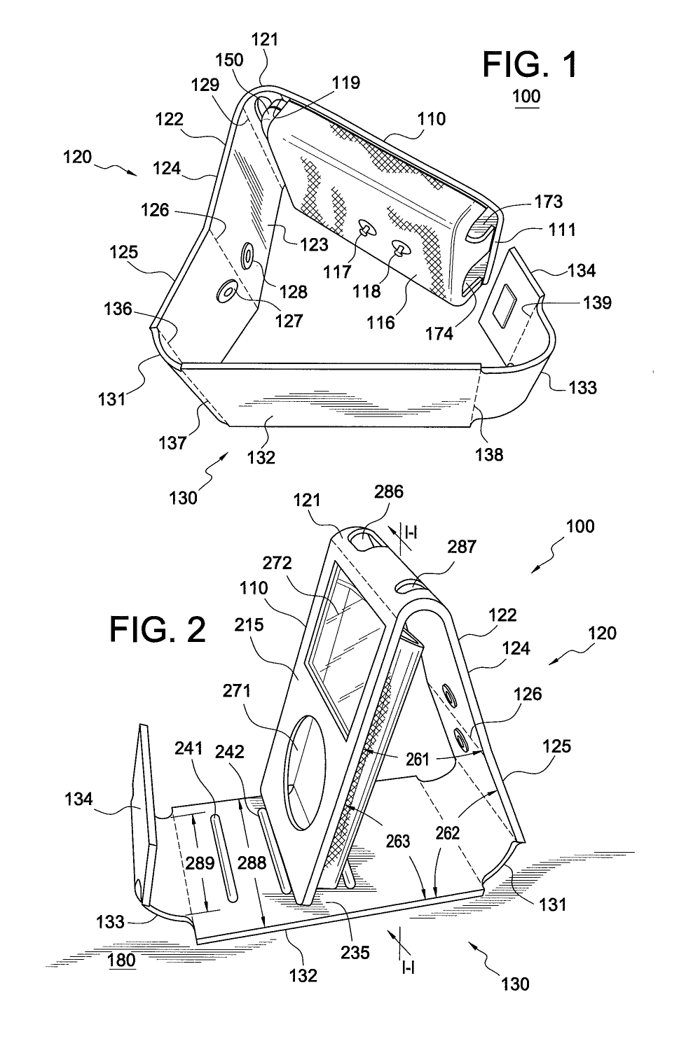

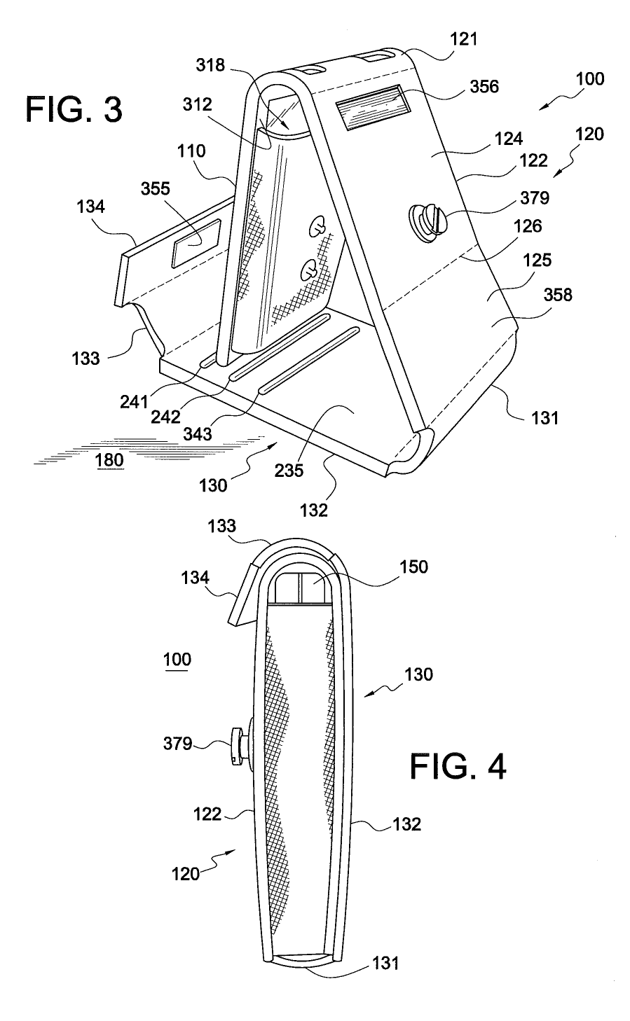

Turning to the drawings, FIG. 1 illustrates a bottom, side isometric view of a case 100 in a first embodiment of an open configuration and enclosing an electrical device 150, according to a first embodiment of case 100. FIG. 2 illustrates a top, front, side isometric view of case 100 in a second embodiment of an open configuration, according to the first embodiment of case 100. FIG. 3 illustrates top, back, side isometric view of case 100 in a third embodiment of the open configuration, according to the first embodiment of case 100. FIG. 4 illustrates a side view of case 100 in a closed configuration and enclosing electrical device 150, according to the first embodiment of case 100. Case 100 is merely exemplary and is not limited to the embodiments presented herein. Case 100 can be employed in many different embodiments or examples not specifically depicted or described herein.

In some embodiments, a holder or case 100 for electrical device 150 can include: (a) an inner portion 110 with a bottom surface 111; (b) an outer section 120 adjacent to inner portion 110; (c) an outer section 130 adjacent to outer section 120; and (d) one or more supports or ribs 241, 242, and 343 adjacent to outer section 130.

In some embodiments, case 100 can also include a connector 379 at an exterior surface 358 of outer section 120. As an example, connector 379 can be configured to couple to a clip (not shown) on a belt.

Case 100 is configured to be removably coupled to electrical device 150. In one example, inner portion 110 is configured to be coupled to electrical device 150. In alternative embodiments, outer section 120 is configured to be coupled to electrical device 150.

In one embodiment, outer section 120 can include: (a) a portion 121 adjacent to inner portion 110; and (b) a portion 122 adjacent to portion 121. Portion 122 can include an interior surface 123.

In various embodiments, at least a part of inner portion 110 can be contiguous with and/or continuous with at least a part of portion 121. Likewise, at least a part of portion 121 can be contiguous with and/or continuous with at least a part of portion 122. Furthermore, in some embodiments, inner portion 110 can be coupled to portion 121 at or by a hinge 119 with inner portion 110 and portion 121 configured to be folded along hinge 119. Likewise, portion 121 can be coupled to portion 122 at or by a hinge 129 with portions 121 and 122 configured to be folded along hinge 129.

In the same or a different embodiment, outer section 130 can include: (a) a portion 131 adjacent to portion 122; (b) a portion 132 with an interior surface 235 and adjacent to portion 131; (c) a portion 133 adjacent to portion 132; and (d) a portion 134 adjacent to portion 133. In one embodiment, ribs 241, 242, and 343 are adjacent to interior surface 235.

In many embodiments, at least a part of portion 131 can be contiguous with and/or continuous with at least a part of portion 122. Likewise, at least a part of portion 131 can be contiguous with and/or continuous with at least a part of portion 132. In the same or different embodiments, at least a part of portion 132 can be contiguous with and/or continuous with at least a part of portion 133. Additionally, in some embodiments, at least a part of portion 133 can be contiguous with and/or continuous with at least a part of portion 134.

In some examples, portion 122 can be coupled to portion 131 at or by a hinge 136 with portions 122 and 131 configured to be folded along hinge 136. Likewise, portion 131 can be coupled to portion 132 at or by a hinge 137 with portions 131 and 132 configured to be folded along hinge 137. In the same or different embodiments, portion 132 can be coupled to portion 133 at or by a hinge 138 with portions 132 and 133 configured to be folded along hinge 138. In some embodiments, portion 133 can be coupled to portion 134 at or by a hinge 139 with portions 133 and 134 configured to be folded along hinge 139. In some embodiments, hinges 119, 129, 136, 137, 138, and/or 139 are rows of stitching that extend across the width of case 100. In other embodiments, hinges 119, 129, 136, 137, 138, and/or 139 are fold lines or a region where two different materials are coupled together. In still other embodiments, case 100 does not include some of or any of hinges 119, 129, 136, 137, 138, or 139, and one or more of portions 121, 131, and 133 serve as the hinges.

In some embodiments, portion 132 can have a width 288, and portion 133 can have a width 289. In some examples, width 289 is less than width 288. For example, width 288 can be four to ten centimeters, and width 289 can be two to six centimeters. In a preferred example, width 288 is approximately six and a half centimeters, and width 289 is approximately five centimeters. Likewise, widths of portions 110, 121, 122, 131, 132, and 134 can be the same at four to ten centimeters. In a preferred example, widths of portions 110, 121, 122, and 132 are each also six and a half centimeters, and width of portion 131 is approximately five and a half centimeters.

In the same or different embodiments, width 289 is less than width 288, and portion 121 can have at least one aperture 287 to allow a user access to electrical device 150 when case 100 is in a closed configuration. Portion 121 can also allow the user access to electrical device 150 though aperture 287 and one or more apertures 286 when case 100 is in an open configuration.

Case 100 is configured to be placed in open or closed configurations. FIG. 1 illustrates case 100 in a first embodiment of the open configuration. FIGS. 2 and 3 illustrate case 100 in second and third embodiments of the open configuration on a flat surface 180, and FIG. 4 illustrates case 100 in the closed configuration. In the illustrated embodiments, when case 100 is in a closed configuration, outer section 130 wraps around inner portion 110 such that an exterior surface 215 of inner portion 110 contacts and/or is adjacent to interior surface 235.

In some embodiments, electrical device 150 includes: (a) a first side (not shown); (b) a second side (not shown) opposite the first side; and (c) a third side (not shown) adjacent to the first side and the second side. In various examples, the second side of electrical device 150 can include a video screen and/or a control mechanism. When case 100 is placed in a closed configuration and encases electrical device 150, portion 121 is adjacent to the third side of electrical device 150, portion 122 is adjacent to the first side of electrical device 150, and inner portion 110 is adjacent to the second side of electrical device 150.

In some examples, portion 134 can include a coupling mechanism 355, and portion 122 can include a coupling mechanism 356, as shown in FIG. 3. Coupling mechanism 355 can be designed to be coupled to coupling mechanism 356. In some embodiments, attaching coupling mechanisms 355 and 356 to each other secures case 100 in a closed configuration. In alternative embodiments, portion 133 includes a first coupling mechanism and portion 121 includes a second coupling mechanism. In this alternative embodiment, the first coupling mechanism is configured to be coupled to the second coupling mechanism to secure case 100 in a closed configuration.

In some embodiments, coupling mechanism 355 can include one or more connectors that can be coupled to one or more of complementary connectors forming coupling mechanism 356. In one embodiment, coupling mechanisms 355 and 356 are complementary Velcro® material. In other embodiments, coupling mechanisms 355 and 356 can be buttons, string ties, or the like. In some examples, coupling mechanisms 355 and 356 can also contain magnets to help align and couple coupling mechanisms 355 and 356.

In various embodiments, as shown in FIGS. 2 and 3, when case 100 is in the open configuration, the case is configured to be placed in a position such that bottom surface 111 is at least partially supported by interior surface 235 and at least one rib of ribs 241, 242, and 343. Moreover, in this configuration, inner portion 110 forms a non-zero angle 261 with portion 122; portion 122 forms a non-zero angle 262 with portion 132; and portion 132 forms a non-zero angle 263 with inner portion 110. In some embodiments, angles 261, 262, and 263 can be acute angles of a single triangle.

In one example, when bottom surface 111 is partially supported by rib 343, angle 261 can be approximately 30 degrees; angle 262 can be approximately 75 degrees; and angle 263 can be approximately 75 degrees. In the same or a different example, as shown in FIG. 2, when bottom surface 111 is partially supported by rib 242, angle 261 can be approximately 40 degrees; angle 262 can be approximately 70 degrees; and angle 263 can be approximately 70 degrees. Likewise, as shown in FIG. 3, when bottom surface 111 is partially supported by rib 241, angle 261 can be approximately 50 degrees; angle 262 can be approximately 65 degrees; and angle 263 can be approximately 65 degrees.

In other examples, angles 261, 262, and/or 263 are set such that inner portion 110 is at a comfortable viewing or operating position for a user of electrical device 150. In some embodiments, angles 261, 262, and/or 263 can be fixed to complement the features of electrical device 150. For example, if electrical device 150 is mostly used for viewing images or videos, angles 261, 262, and 263 can be different than if the user's interaction with electrical device 150 is mainly to change settings on a touch screen of electrical device 150.

In the same or different examples, portion 121 and portion 132 can provide support to inner portion 110 when case 100 is in the open configuration and inner portion 110 is located over portion 132 with bottom surface 111 adjacent to interior surface 235.

Referring again to FIGS. 1-4, inner portion 110 can include: (a) bottom surface 111; (b) an interior surface 312 adjacent to bottom surface 111; (c) exterior surface 215 adjacent to bottom surface 111 and opposite interior surface 312; and (d) a coupling mechanism 116 at interior surface 312. In some embodiments, when case 100 is placed in a closed configuration, exterior surface 215 is substantially parallel and/or adjacent to interior surface 235.

In some examples, interior surface 312 is configured to be removably coupled to electrical device 150. In one embodiment, interior surface 312 is removably coupled to electrical device 150 using coupling mechanism 116.

Coupling mechanism 116 can be configured to removably enclose electrical device 150. In some examples, coupling mechanism 116 can be a pocket. When coupling mechanism 116 is a pocket, electrical device 150 can be placed inside of coupling mechanism 116 through an opening 318 in coupling mechanism 116. In one embodiment, coupling mechanism 116 is a piece of material sewn or otherwise attached to three sides of interior surface 312. Opening 318 can be located at the unattached side of the material. In some examples, opening 318 is located opposite to bottom surface 111. In some examples, coupling mechanism 116 can include one or more apertures 173 and 174 to allow the user access to portions of electrical device 150. In one embodiment, apertures 173 and 174 allow the user to connect peripheral devices such as headphones or power supplies to electrical device 150 without removing electrical device 150 from case 100. In alternative embodiments, coupling mechanism 116 can be Velcro® material, strings ties, buttons, or the like.

Inner portion 110 can allow a user to view and use electrical device 150 when electrical device 150 is coupled to interior surface 312 and case 100 is in the open configuration. In one example, inner portion 110 can include one or more openings 271 and 272 to allow the user to view and use electrical device 150. In some examples, opening 272 can be covered by a clear material. The clear material can allow the user to view and/or touch a display or touch screen at the second side of electrical device 150, while protecting the screen from damage. In one example, the clear material is a clear plastic, for example, clear polyvinyl chloride (PVC).

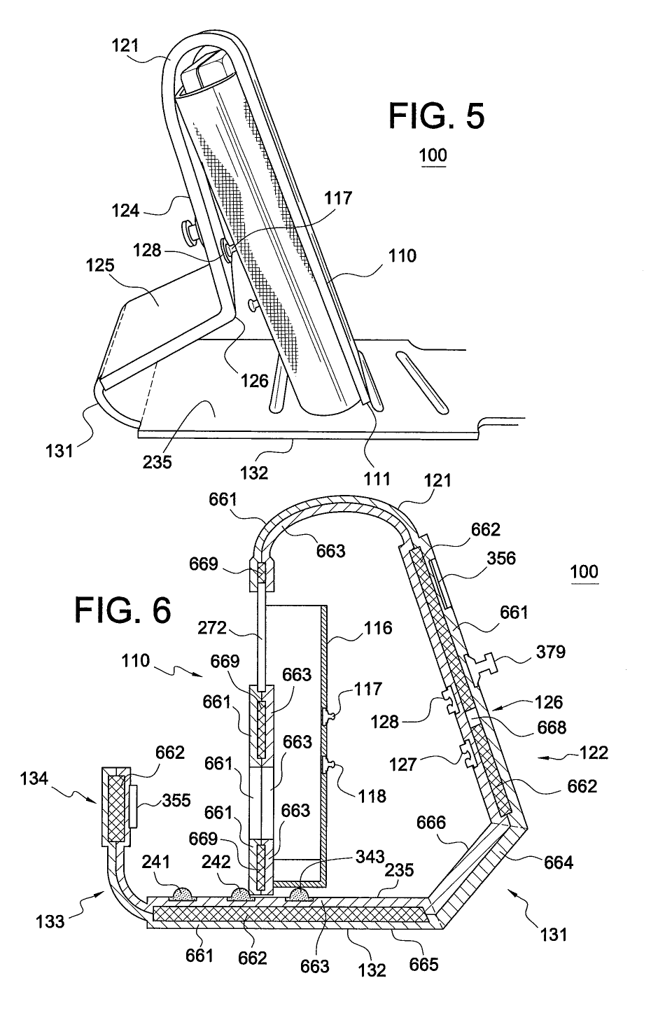

FIG. 5 illustrates a top, front, side isometric view of case 100 in a fourth embodiment of the open configuration, according to the first embodiment of case 100. As shown in FIGS. 1, 2, 3, and 5, portion 122 can include: (a) a segment 124 adjacent to portion 121; (b) a segment 125 adjacent to segment 124 and portion 131. In some examples, a bend region 126 separates and/or couples segment 124 from segment 125.

Segment 124 is configured to be bent relative to segment 125 at bend region 126. In various examples, allowing segment 124 to be bent relative to segment 125 can increase the stability of case 100 when case 100 is in the open configuration and inner portion 110 is located over portion 132 with bottom surface 111 adjacent to interior surface 235.

In some embodiments, inner portion 110 can further include attachment mechanisms 117 and 118. In the same embodiment, portion 121 can include attachment mechanisms 127 and 128. Attachment mechanism 117 can include one or more connectors that can be coupled to one or more complementary connectors forming attachment mechanism 128. Likewise, attachment mechanism 118 can include one or more connectors that can be coupled to one or more complementary connectors forming attachment mechanism 127.

In one embodiment, attachment mechanisms 117 and 118 can be identical to or substantially similar to coupling mechanism 355. Moreover, attachment mechanisms 127 and 128 can be identical to or substantially similar to coupling mechanism 356.

In one example, attachment mechanisms 117 and 118 are adjacent to coupling mechanism 116. In the same or different embodiments, attachment mechanisms 127 and 128 are located at segments 125 and 124, respectively. In some examples, attachment mechanisms 117 and 118 can be male buttons, and attachment mechanisms 127 and 128 can be female buttons. In other embodiments, attachment mechanisms 117, 118, 127, and 128 are Velcro® material, strings ties, magnets, or the like.

Attachment mechanisms 117 and 118 can be coupled to attachment mechanisms 128 and 127, respectively, when case 100 is in a closed configuration. As shown in FIG. 5, attachment mechanism 117 can also be capable of being coupled to attachment mechanism 128 when case 100 is in open configuration and inner portion 110 is located over portion 132 with bottom surface 111 adjacent to interior surface 235. In some embodiments, segment 124 bends relative to segment 125 at bent region 126 when attachment mechanism 117 is coupled to attachment mechanism 128 and case 100 is in the open configuration with bottom surface 111 adjacent to interior surface 235. In alternative embodiments, attachment mechanisms 117 and 118 can both be coupled to attachment mechanisms 128 and 127, respectively, when case 100 is in the open configuration and inner portion 110 is located over portion 132 with bottom surface 111 adjacent to interior surface 235.

Referring back to FIGS. 2 and 3, interior surface 235 of portion 132 can include ribs 241, 242, and 343. In some examples, one or more of ribs 241, 242, and 343 extend in first direction and are substantially parallel to each other. In various embodiments, the first direction is substantially parallel to width 288 of interior surface 235 embodiments. In some examples, ribs 241, 242, and 343 extend approximately 70 to 90 percent of width 288 and have a thickness of two to four millimeters.

In various embodiments, rib 241 is separated from rib 242 by approximately ten to twenty millimeters. For example, rib 241 can be separated from rib 242 by fifteen millimeters. In the same or different examples, rib 242 can be separated from rib 343 by ten to twenty millimeters. In some embodiments, the distance between ribs 241, 242, and 343 is set based on the dimensions of electrical device 150. In some examples, the distances between adjacent ribs are the same. In other embodiments, the distance between adjacent ribs varies.

FIG. 6 illustrates a cross-sectional view along line I-I (FIG. 2) of case 100, according to the first embodiment of case 100. In the embodiment illustrated in FIG. 6, portion 132 can include: (a) an outer layer 661 with an exterior surface 665; (b) a stiffener layer 662 coupled to outer layer 661; (c) an inner layer 663 with interior surface 235 and coupled to stiffener layer 662.

In one embodiment, outer layer 661 and inner layer 663 can extend continuously through portions 133 and 134. However, in the embodiment illustrated in FIG. 6, portion 134 includes stiffener layer 662, but portion 133 does not include stiffener layer 662. In some examples, stiffener layer 662 is not present in portion 133 to allow easier folding of case 100 between the open and closed configurations.

In the embodiment illustrated in FIG. 6, portion 131 includes; (a) an inner layer 666; and (b) an outer layer 664. In some embodiments, inner layer 666 and outer layer 664 are made from different material than inner layer 663 and outer layer 661, respectively. In the same or a different embodiment, inner layer 666 and outer layer 664 are made from the same material. In alternative embodiments, portion 131 can include a stiffener layer. In the same or different examples, portion 131 can be made from the same material as coupling mechanism 116.

Portion 122 can include: (a) outer layer 661; (b) inner layer 663; and (c) stiffener layer 662 present throughout portion 122 except at bend region 126. In some embodiments, at bend region 126, a void region 668 exists between inner layer 663 and outer layer 661 to facilitate folding at bend region 126.

In the same or different embodiments, portion 121 can include: (a) outer layer 661; and (b) inner layer 663 coupled to outer layer 661. In alternative embodiments, portion 121 can include stiffener layer 662 between outer layer 661 and inner layer 663.

In inner portion 110, outer layer 661 and inner layer 663 can extend around the edges of openings 271 and 272. In some embodiments, inner portion 110 can include a stiffener layer 669. In many examples, stiffener layer 669 can be made from a different material than stiffener layer 662. For example, stiffener layer 662 can be composed of a material that provides more cushioning and protection than stiffener layer 669. In alternative embodiments, stiffener layers 662 and 669 can be made from the same material.

In an alternative example, portions 134, 132, 122, and/or 110 do not include a stiffener layer, or portions 110, 121, 122, 131, 132, 133, and 134 all include a stiffening layer. In yet another embodiment, inner portion 110, outer section 120, and/or outer section 130 are formed by a single layer (e.g., outer layer 661 or inner layer 663). In the same or different embodiments, coupling mechanism 116 can also include a stiffener layer.

Referring again to FIG. 6, outer layers 661 and 664 can be composed of a first material, and inner layers 663 and 666 can be composed of a second material. In some embodiments, outer layers 661 and 664 and inner layers 663 and 666 are made of leather (for example, split leather), suede, PVC, polyurethane, nylon, fabric, or the like. Stiffener layers 662 and 669 can be composed of cardboard, plastic, foam, or the like. In one example, stiffener layers 662 and 669 can include a layer of acrylonitrile butadiene styrene (ABS) and/or cardboard. In some embodiments, stiffener layers 662 and 669 lend rigidity and padding to case 100 to provide protection for electrical device 150 (FIGS. 1, 4, and 5).

In some examples, outer layer 661, stiffener layer 662, and inner layer 663 are stitched together. In other examples, some or all of outer layer 661, stiffener layer 662, and inner layer 663 can be attached together with an adhesive, for example, instead of or in addition to stitching.

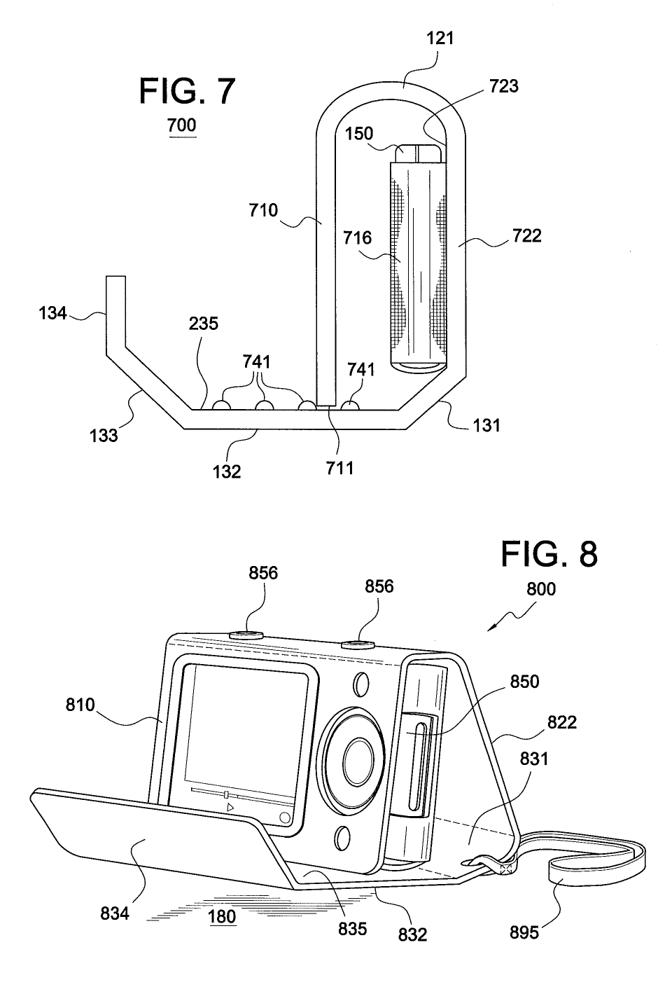

Turning to another embodiment, FIG. 7 illustrates a side view of a case 700 in an open configuration and enclosing electrical device 150, according to a second embodiment of case 100 (FIG. 1). Case 700 can include: (a) an inner portion 710 with a bottom surface 711; (b) an outer portion 722; (c) portions 121, 131, 132, 133, and 134; and (d) at least four ribs 741 at portion 132. When case 700 is placed in an open configuration, inner portion 710 is capable of being located over portion 132 with bottom surface 711 adjacent to interior surface 235.

In this embodiment, outer portion 722 is configured to be removably coupled to electrical device 150. In the example illustrated in FIG. 7, outer portion 722 can include a coupling mechanism 716 (e.g., a pocket) at an interior surface 723. In one example, coupling mechanism 716 can be identical to or substantially similar to coupling mechanism 116 (FIG. 1). In some embodiments, outer portion 722 can include openings (not shown) identical to or substantially similar to openings 271 and 272 (FIG. 2).

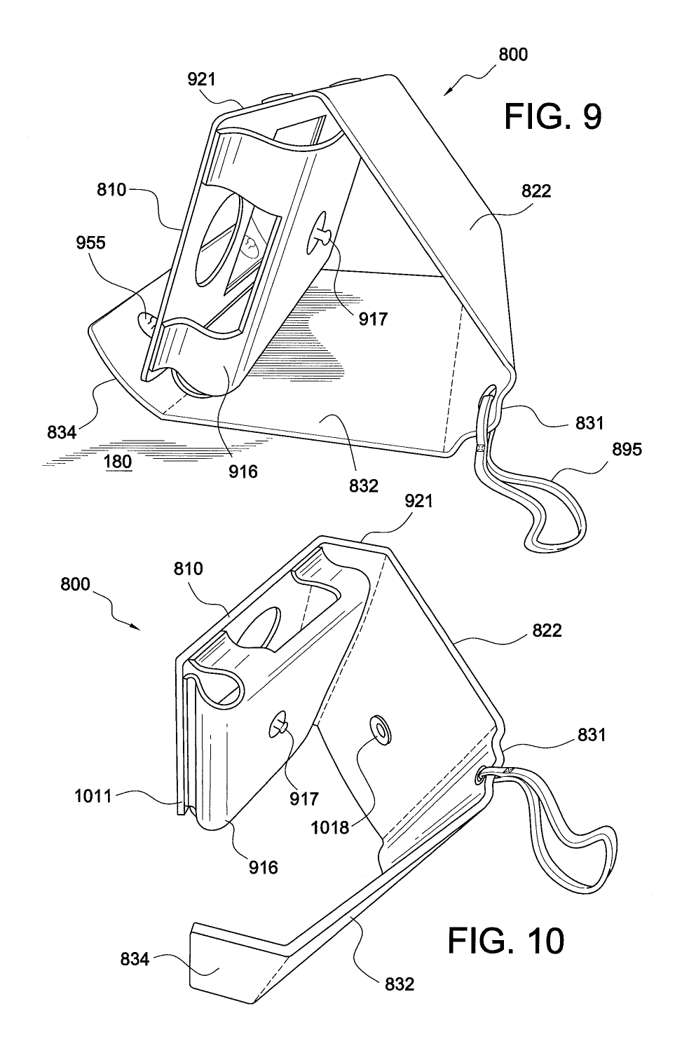

Turning to a further embodiment, FIG. 8 illustrates a top, front, side isometric view of a case 800 in a first embodiment of an open configuration and enclosing an electrical device 850, according to a third embodiment of case 100 (FIG. 1). FIG. 9 illustrates a top, back, side isometric view of case 800 in a second embodiment of the open configuration, according to the third embodiment of case 100 (FIG. 1). FIG. 10 illustrates a bottom, side isometric view of case 800 in a third embodiment of the open configuration, according to the third embodiment of case 100 (FIG. 1). In the embodiment illustrated in FIGS. 8-10, case 800 is configured to enclose electrical device 850. In some examples, electrical device 850 can have a different shape and/or size than electrical device 150 (FIGS. 1 and 5).

In some examples, case 800 can include: (a) an inner portion 810 with an coupling mechanism 916 and a bottom surface 1011; (b) a portion 921 adjacent to inner portion 810; (c) a portion 822 adjacent to portion 921; (d) a portion 831 adjacent to portion 822; (e) a portion 832 with an interior surface 835 and adjacent to portion 831; and (f) a portion 834 adjacent to portion 832. In some examples, case 800 does not include a portion similar to portion 133 (FIG. 1) and/or ribs 241, 242, and 343 (FIGS. 2 and 3) at portion 832. In alternative embodiments, case 800 can include portion 133 (FIG. 1) and/or ribs 241, 242, and/or 343 (FIGS. 2 and 3). When case 800 is placed in an open configuration, inner portion 810 is capable of being located over portion 832 with bottom surface 1011 adjacent to interior surface 835.

In some examples, coupling mechanism 916 can be identical to or substantially similar to coupling mechanism 116 (FIG. 1). In the same or different examples, an attachment mechanism 917 can be located at or adjacent to coupling mechanism 916. Portion 822 can include an attachment mechanism 1018 configured to be coupled to attachment mechanism 917. In some examples, portion 831 can include a coupling mechanism 895 configured to facilitate easy carrying of case 800 and electrical device 850 by a user.

Portion 834 can include a coupling mechanism 955, and a portion 921 can include a coupling mechanism 856. Coupling mechanism 955 can be configured to be coupled to coupling mechanism 856 to secure case 800 in the closed configuration. In some embodiments, attachment mechanisms 917 and 1018 can also be coupled to help hold case 800 in the closed configuration.

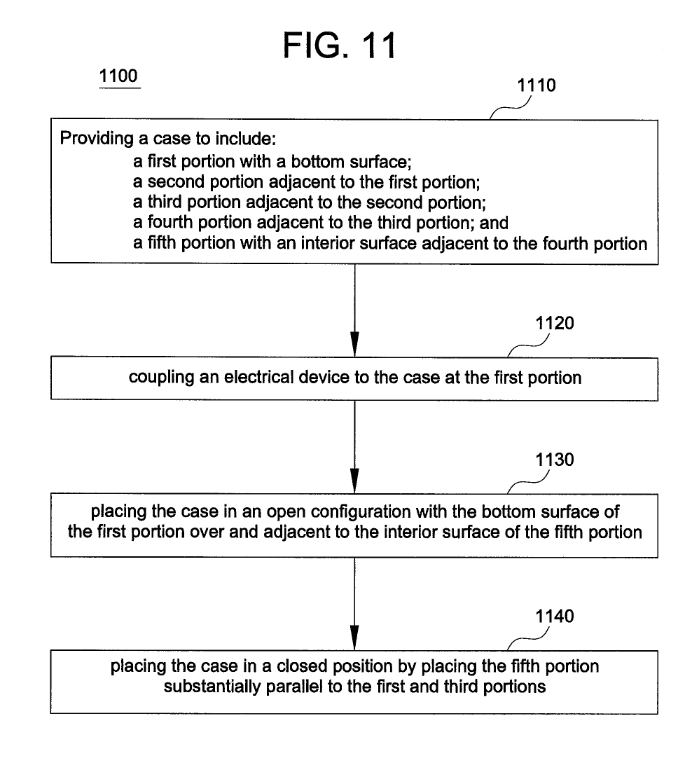

FIG. 11 illustrates a flow chart 1100 for an embodiment of a method of using a case with an electrical device. Flow chart 1100 includes a step 1110 of providing a case to include: (a) a first portion with a bottom surface; (b) a second portion adjacent to the first portion; (c) a third portion adjacent to the second portion; (d) a fourth portion adjacent to the third portion; and (e) a fifth portion with an interior surface and adjacent to the fourth portion. As an example, the case can be similar to cases 100, 700, or 800 of FIGS. 1, 7, and 8, respectively. In some embodiments, the first portion can be similar to inner portions 110, 710 or 810 of FIGS. 1, 7, and 8, respectively. Likewise, the second portion can be similar to portions 121 or 921 of FIGS. 1 and 9, respectively. The third portion can be similar to outer portions 122, 722, or 822 of FIGS. 1, 7, and 8, respectively. The fourth portion can be similar to portions 131 or 831 of FIGS. 1 and 8, respectively. The fifth portion can be similar to portions 132 or 832 of FIGS. 1 and 8, respectively. In the same or a different embodiment, the bottom surface can be similar to bottom surfaces 111, 711, or 1011 of FIGS. 1, 7, and 10, respectively, and the interior surface can be similar to interior surfaces 235, and 835 of FIGS. 2 and 8, respectively.

Flow chart 1100 in FIG. 11 continues with a step 1120 of coupling the electrical device to the case. As an example, the electrical device can be coupled to the case similar to the coupling of electrical devices 150 and 850 to portions 110 or 810 in FIGS. 1 and 8, respectively. In an alternative example, the electrical device can be coupled to the case similar to the coupling of electrical device 150 to outer portion 722 in FIG. 7. For example, the electrical device can be coupled to the case using an attachment mechanism similar to coupling mechanisms 116, 716, or 916 of FIGS. 1, 7, and 9, respectively.

Subsequently, flow chart 1100 includes a step 1130 of placing the case in an open configuration with the bottom surface of the first portion over and adjacent to the interior surface of the fifth portion. As an example, the case can be placed in an open configuration similar to the open configuration of case 100 in FIGS. 2, 3, and 5, case 700 in FIG. 7, and case 800 in FIGS. 8 and 9. In some embodiments, placing the bottom surface of the first portion over and adjacent to the interior surface of the fifth portion can be similar to the configuration of inner portion 110, portion 132, bottom surface 111, and interior surface 235 as shown in FIGS. 2, 3, and 5. In other embodiments, placing the bottom surface of the first portion over and adjacent to the interior surface of the fifth portion can be similar to the configuration of inner portion 710, portion 132, bottom surface 711 and interior surface 235 as shown in FIG. 7. In still further embodiments, placing the bottom surface of the first portion over and adjacent to the interior surface of the fifth portion can be similar to the configuration of inner portion 810, portion 832, bottom surface 1011, and interior surface 835 as shown in FIG. 8, 9, or 10.

In some embodiments, placing the case in the open configuration can also include removably attaching the first portion to the third portion. As an example, the first portion can be removably attached to the third portion similar to the coupling of inner portion 110 to portion 122 as shown in FIG. 5.

Next, flow chart 1100 includes a step 1140 of placing the case in a closed configuration by placing the fifth portion substantially parallel to the first and third portions. As an example, the case can be placed into the closed configuration similar to the closed portion of case 100 as shown in FIG. 4. In some examples, placing the fifth portion substantially parallel to the first and third portions can be similar to the placement of portion 132 substantially parallel to portions 110 and 122, as shown in FIG. 4.

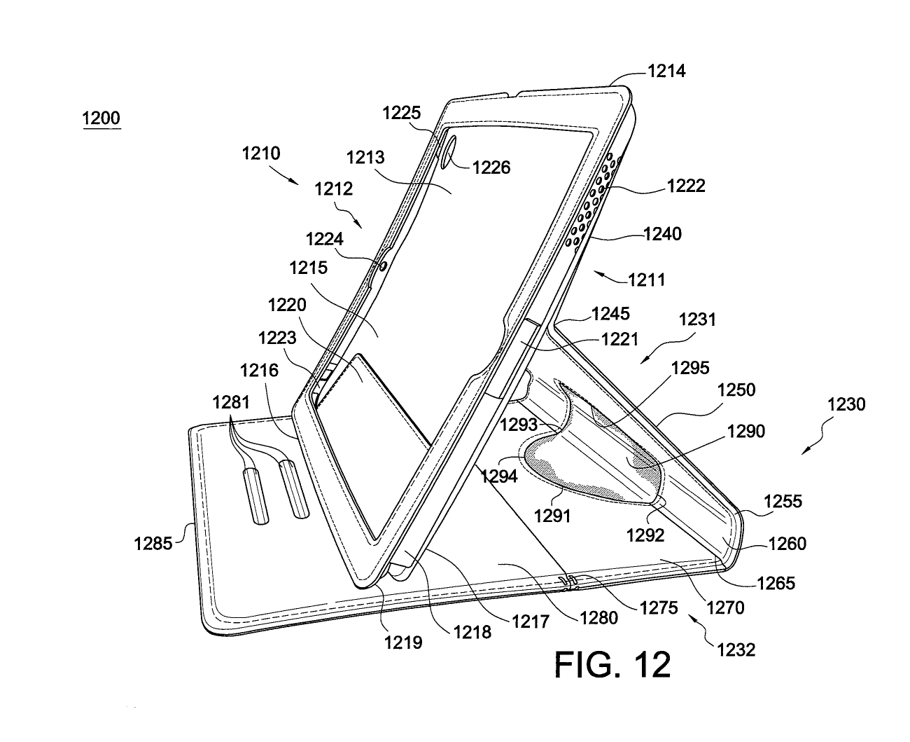

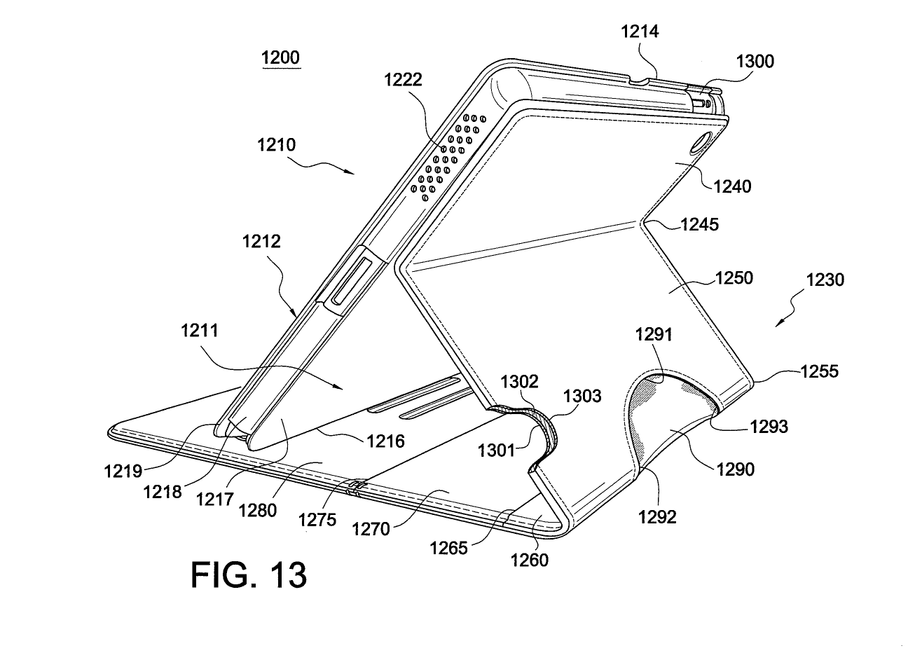

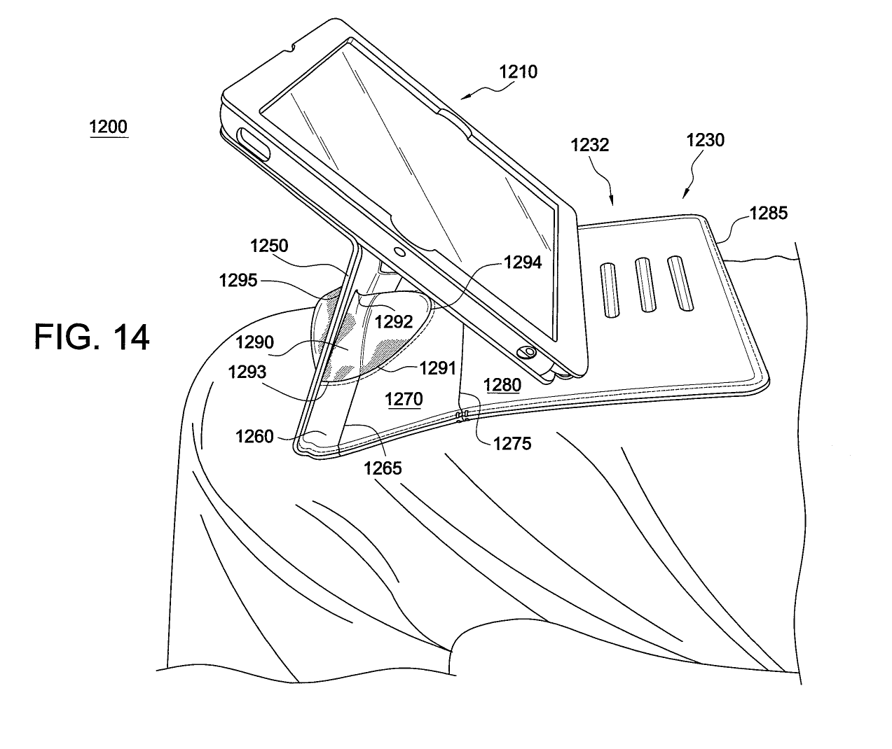

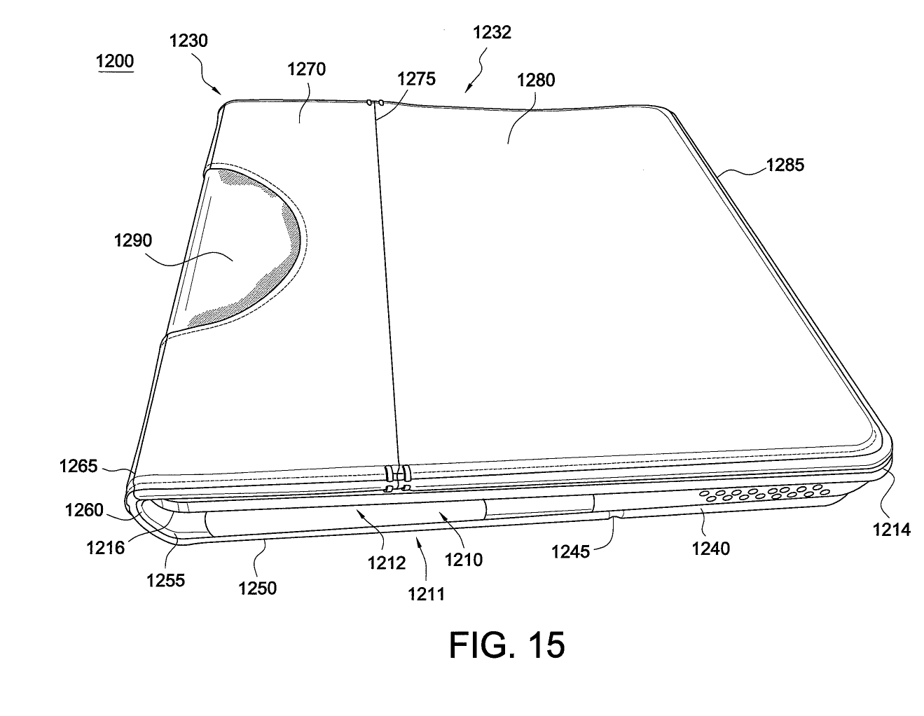

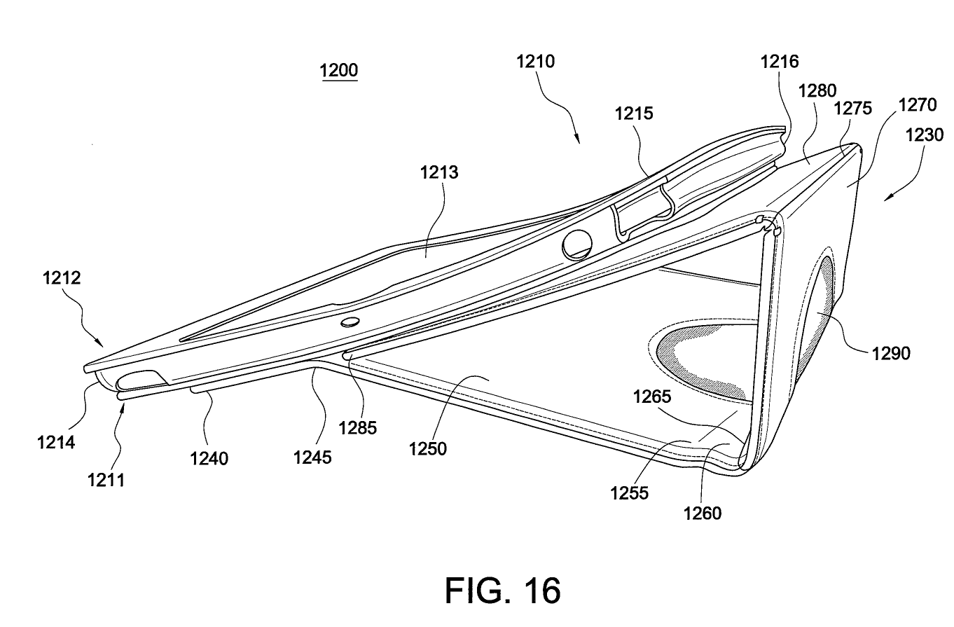

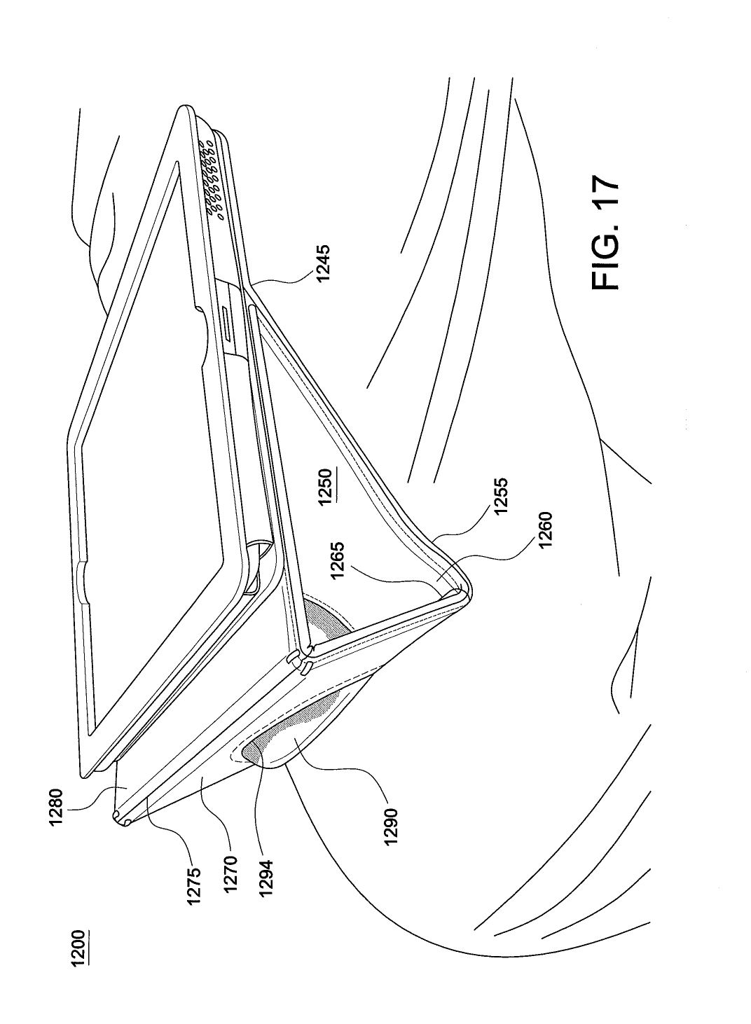

FIGS. 12 to 17 illustrate an example of an apparatus for supporting an electronic device, such as a tablet computer, from a user's leg. In the following paragraphs, the electronic device is described as a tablet computer, but it should be understood that in some embodiments, a different electronic device (e.g., having a touch screen) can be supported, contained within a case, or both. Various embodiments of a tablet computer case can be configured to hold and secure a tablet computing device, such as the iPad, developed and sold by Apple, Inc., of Cupertino, Calif. Embodiments of a tablet computer case can include a tablet computer lap stand case and a tablet computer rotatable case. Embodiments of a tablet computer lap stand case can be configured to allow the tablet computing device (a) to be opened in a viewing configuration at various viewing angles for use on a surface (as shown in FIGS. 12 and 13, described below) and/or for use on a leg (as shown in FIG. 14, described below), (b) to be closed in a closed configuration (as shown in FIG. 15, described below) in which the tablet computing device is secured inside the case, and/or (c) to be opened in a typing configuration for use on a surface (as shown in FIG. 16, described below) and/or for use on a leg (as shown in FIG. 17, described below). Embodiments of the tablet computer lap stand case can include a shape-forming region or a leg-conforming region that can shape around a user's leg to provide a comfortable and/or secure resting of the tablet computer lap stand case on a user's leg when configured in the viewing configuration and/or typing configuration. The tablet computer lap stand case can automatically shape around the user's leg, in some embodiments, based on the weight of the tablet computing device parts of the tablet computer lap stand case.

FIG. 12 is a front right side perspective view showing various elements of a tablet computer lap stand case 1200 in a viewing configuration. FIG. 13 is a back right side perspective view showing various elements of tablet computer lap stand case 1200 in a viewing configuration. Tablet computer lap stand case 1200 is merely exemplary and embodiments of the tablet computer lap stand case, apparatus for supporting an electrical device or tablet computer, or the like, are not limited to the embodiments presented herein. The tablet computer lap stand case can be employed in many different embodiments or examples not specifically depicted or described herein. In many embodiments, tablet computer lap stand case 1200 can include a tablet support assembly 1210 and a tablet case cover 1230. In some embodiments, tablet support assembly 1210 can include a back side 1211 and a front side 1212. In various embodiments, tablet support assembly 1210 can include a first region 1213 and a second region 1215, such that when tablet computer lap stand case 1200 is configured in a viewing configuration, as shown in FIG. 12, first region 1213 is located at the top of tablet support assembly 1210 and second region 1215 is located at the bottom of tablet support assembly 1210. Tablet support assembly 1210 can include a first edge 1214, which can be located at the top of first region 1213 when tablet computer lap stand case 1200 is configured in a viewing configuration. Tablet support assembly 1210 can further include a second edge 1216, which can be located at the bottom of second region 1215 when tablet computer lap stand case 1200 is configured in a viewing configuration. In certain embodiments, first edge 1214 can include one or more first edge magnets (not shown), and/or second edge 1216 can include one or more second edge magnets (not shown).

In some embodiments, tablet support assembly 1210 can securely support and/or encase the tablet computing device. In certain embodiments, tablet support assembly 1210 can be substantially rectangular and can be of sufficient dimension to hold and secure the tablet computing device. In various embodiments, tablet support assembly 1210 can include a tablet support back cover 1217 on back side 1211, a tablet support front perimeter 1219 on front side 1212, and one or more tablet support sides 1218 extending between tablet support back cover 1217 and tablet support front perimeter 1219. Tablet support back cover 1217, tablet support front perimeter 1219, and tablet support sides 1218 together can, respectively, enclose the back, the sides, and the perimeter of the face of the tablet computing device while allowing the touchscreen of the tablet computing device to be uncovered and accessible for user manipulation.

In some embodiments, tablet support assembly 1210 can include a tablet insertion slot along a side of tablet support assembly 1210, such as along second edge 1216. Tablet support assembly can include a flap 1220 extending longitudinally along the tablet insertion slot and can be attached on one side to tablet support front perimeter 1219. Flap 1220 can extend from tablet support perimeter face to wrap around the tablet computing device and be tucked between the back of tablet computing device and tablet support back cover 1217. Flap 1220 and tablet support back cover 1217 can include one or more fasteners, such as hook-and-loop tape and/or one or more snaps, to secure the flap in place and to securely hold the tablet computing device within tablet support assembly 1210.

In certain embodiments, tablet support back cover 1217, tablet support front perimeter 1219, and/or tablet support sides 1218 can include various holes, grooves, apertures, and/or slots which can allow a user to control the tablet device and/or to connect plugs for peripherals or other connectors to the tablet computing device when it is secured in tablet support assembly 1210, and which can provide an aperture to allow sound waves and/or electromagnetic waves, such as light, to pass through. For example, FIG. 12 shows tablet support assembly 1210 including various slots for an iPad, including a dock connector slot 1221 configured to allow an iPad docking cable to connect to the iPad's dock connector, a speaker slot 1222 configured to allow sound from the iPad speaker to pass through and not be as muffled by tablet support assembly 1210, an audio slot 1223 configured to allow an audio jack to connect the iPad's audio receptacle, a microphone slot 1224 configured to allow sound to pass through tablet support assembly 1210 to the iPad's microphone, a sleep slot 1225 configured to allow a user to manipulate the iPad's sleep/wake button, and a camera slot 1226 configured to allow light to pass through tablet support assembly 1210 to the iPad's back camera. Additionally, FIG. 13 shows tablet support assembly 1210 including a button slot 1300 configured to allow a user to manipulate volume buttons on the iPad. In other embodiments, various other holes, grooves, and/or slots are included for various other configurations of tablet computing devices.

The component parts of tablet support assembly 1210, such as tablet support back cover 1217, tablet support front perimeter 1219, and/or tablet support sides 1218, can be made of leather (for example, split leather), suede, PVC, polypropylene, polyethylene, nylon, fabric, or another such suitable material. In some embodiments, the parts can include two or more layers of the same or different such materials. The parts can include stiffener layers between the layers to provide additional structural support. Stiffener layers can be made of a suitable rigid or semi-rigid material, such as cardboard, acrylonitrile butadiene styrene (ABS), plastic, foam, or another such suitable material. In certain embodiments, the layers can be stitched together or attached together with an adhesive. For example, the inner surfaces of tablet support back cover 1217, tablet support front perimeter 1219, and flap 1220 that can be configured to rest against and hold the tablet computing device can be composed of grip suede, and the outer surfaces can be composed of dry touch micro fiber.

In other embodiments, tablet support assembly 1210 can be replaced with other assemblies such as X-frames and the like. As an example, these other assemblies can be made of rigid plastic.

In various embodiments, tablet case cover 1230 can include a tablet case back cover 1231 and a tablet case front cover 1232, and a hinge or spine 1260. Tablet case back cover 1231 can include a back cover first region 1240 and a back cover second region 1250. Tablet case front cover 1232 can include a front cover second region 1270 and a front cover first region 1280. In some embodiments, back cover first region 1240 can be coupled to back cover second region 1250 at a back cover hinge 1245, and front cover first region 1280 can be coupled to front cover second region 1270 at a front cover hinge 1275. Back cover second region 1250 can be coupled to spine 1260 at a back edge of spine 1255, and front cover second region 1270 can be coupled to spine 1260 at a front edge of spine 1265. Back cover first region 1240 can be attached to tablet support back cover 1217 and can extend from first edge 1214 partially down tablet support assembly 1210 between first edge 1214 and second edge 1216 to back cover hinge 1245. Back cover hinge 1245 can be located closer to first edge 1214 than to second edge 1216. Back cover second region 1250 can extend from back cover hinge 1245 down to back edge of spine 1255, such that the dimension along tablet case back cover 1231 from back cover hinge 1245 to back edge of spine 1255 is substantially similar to the dimension along tablet support back cover 1217 from back cover hinge 1245 to second edge 1216.

In various embodiments, spine 1260 can have a dimension from back edge of spine 1255 to front edge of spine 1265 that is substantially similar to the dimension of tablet support assembly 1210 from tablet support back cover 1217 to tablet support front perimeter 1219. In certain embodiments, tablet case front cover 1232 can extend from front edge of spine 1265 to a third edge 1285 such that the dimension from front edge of spine 1265 to third edge 1285 is substantially similar to the dimension along tablet support assembly 1210 from second edge 1216 to first edge 1214. In a number of embodiments, front cover first region 1280 includes one or more third edge magnets (not shown) along or near third edge 1285.

In some embodiments, back cover first region 1240, back cover second region 1250, front cover second region 1270, and/or front cover first region 1280 can be made of leather (for example, split leather), suede, PVC, polypropylene, polyethylene, nylon, fabric, or another such suitable material. In a number of embodiments, these portions of tablet case cover 1230 can be made of two or more layers of the same or different such materials. The portions can include stiffener layers between the layers to provide additional structural support. Stiffener layers can be made of a suitable rigid or semi-rigid material, such as cardboard, ABS, plastic, foam, or another such suitable material. In certain embodiments, the layers can be stitched together or attached together with an adhesive. For example, the inner surfaces of certain portions of tablet case cover 1230 (e.g., 1240, 1250, 1270, and 1280), can be composed of grip suede, and the outer surfaces can be composed of dry touch micro fiber. These inner and outer layers can be stitched together and/or adhered surrounding an interior layer of plastic used to provide structural support.

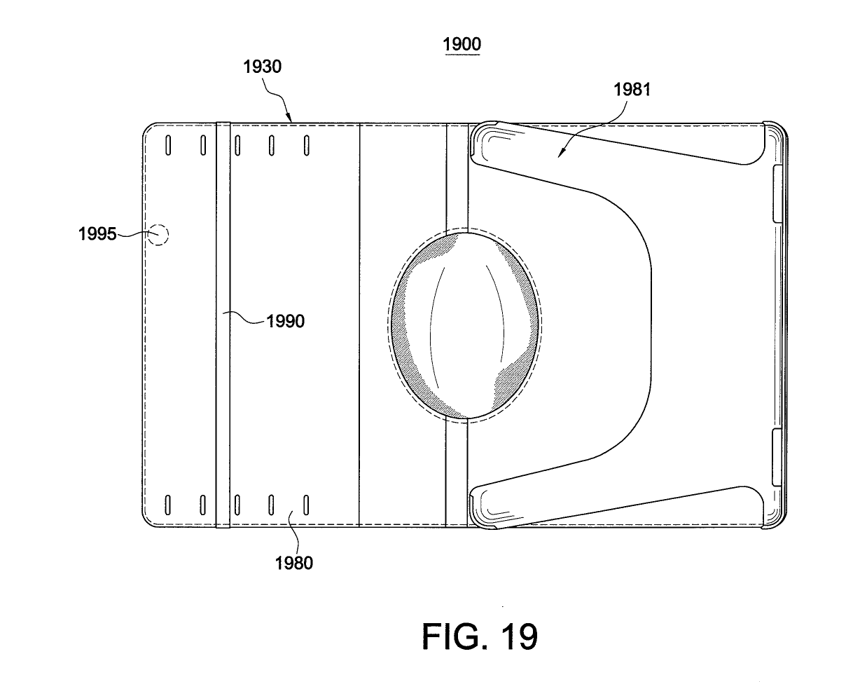

In various embodiments, tablet case cover 1230 can include a shape-forming region 1290. Shape forming region 1290 can be a leg-conforming region, for example. Shape-forming region 1290 can be located along spine 1260, in some embodiments, and can extend partially up back cover second region 1250 between back edge of spine 1255 and back cover hinge 1245, and can extend partially down front cover second region 1270 between front edge of spine 1265 and front cover hinge 1275. In some embodiments, shape-forming region 1290 can be substantially centered across spine 1260, such that shape-forming region 1290 can extend approximately the same distance up back cover second region 1250 as it extends down front cover second region 1270. In other embodiments, shape-forming region 1290 can extend a greater distance up back cover second region 1250 than it extends down front cover second region 1270. In yet additional embodiments, shape-forming region 1290 can extend a greater distance down front cover second region 1270 than it extends up back cover second region 1250. In many embodiments, shape-forming region 1290 can be substantially centered between the sides of spine 1260. Shape-forming region 1290 can be attached to tablet case cover 1230 along a rounded edge 1291, and can extend from a first spine side edge 1293 to a second spine side edge 1292, and from a front cover edge 1294 to a back cover edge 1295. As an example, shape-forming region 1290 can extend between 9 and 15 centimeters from first spine side edge 1293 to second spine side edge 1292. In another example, shape-forming region 1290 can extend 11.3 centimeters from first spine side edge 1293 to second spine side edge 1292. As another example, shape-forming region 1290, when fully unfolded (similarly as shown in FIG. 19, described below), can extend between 6 and 12 centimeters from front cover edge 1294 to back cover edge 1295. In another example, shape-forming region 1290, when fully unfolded, can extend 8.6 centimeters from front cover edge 1294 to back cover edge 1295.

Rounded edge 1291 can have a substantially circular or elliptical shape of sufficient dimension to allow shape-forming region 1290, when configured in a viewing configuration and/or typing configuration to conform around the top of a user's leg, as shown in FIGS. 14 and 17, and described below. Shape-forming region 1290 can be made of a flexible and/or elastic material, such as neoprene, nylon, spandex, foam, or another suitable material, such that shape-forming region 1290 can flexibly and conform around the top of a user's leg as a result of the weight of the tablet computing device in tablet support assembly 1210 and parts of tablet computer lap stand case 1200. In many embodiments, this conformity or deformation can occur without the use of any other weight or object. In other embodiments, shape-forming region 1290 can be a hole without any material.

Spine 1260 can include two segments on each side of shape forming region 1290. As an example, each spine segment can be the same length, such as approximately 1 centimeter to 9 centimeters long from the outer edge of spine 1260 to the edge of shape-forming region 1290. In another example, each spine segment can be approximately 6.2 cm long. In some embodiments, spine 1260 can be made of leather (for example, split leather), suede, PVC, polypropylene, polyethylene, nylon, fabric, or another such suitable material. In some embodiments, spine 1260 can be made of two or more layers of the same or different such materials. In a number of embodiments, portions of tablet case cover 1230 (e.g., 1240, 1250, 1260, 1270, 1280) can be made of one or more layers that extend across the portions of tablet case cover 1230. For example, the inner surfaces of portions 1240, 1250, 1260, 1270, and 1280 can be composed of a single piece of grip suede, the outer surfaces of such portions can be composed of a single piece of dry touch micro fiber, and, in some embodiments, each portion except spine 1260 can include an interior stiffener piece that extends between each hinge (1245, 1255, 1265, 1275) to provide structural support. The hinges (e.g., 1245, 1255, 1265, 1275) can be formed by the absence of stiffener pieces at each hinge region. In such embodiments, tablet case cover may include a circular or elliptical cut-out for shape-forming region 1290.

In some embodiments, tablet support assembly 1210 can be positioned in a viewing configuration, as shown in FIGS. 12 and 13, such that first edge 1214 is positioned above second edge 1216, and second edge 1216 touches the inner surface of tablet case front cover 1232, but first edge 1214 does not touch tablet case front cover 1232. In various embodiments, tablet support assembly 1210 can fold axially around back cover hinge 1245. In many embodiments, hinge or spine 1260 can provide an axial hinge for back cover second region 1250, allowing back cover second region 1250 to adjust to various angles. Together, these hinges can allow tablet support assembly 1210 to be adjusted to various viewing angles, such that second edge 1216 can rest upon various positions on the inner surface of tablet case front cover 1232 and back cover second region 1250 can prop up back side 1211 of tablet support assembly 1210. In some viewing configurations, back cover first region 1240 can form a substantially right angle with back cover second region 1250. In other viewing configurations, tablet support assembly 1210 can be positioned at a more upright viewing position, such that back cover first region 1240 forms an obtuse angle with back cover second region 1250 at back cover hinge 1245. In other viewing configurations, tablet support assembly 1210 can be positioned at a less upright viewing position, such that back cover first region 1240 forms an acute angle with back cover second region 1250 at back cover hinge 1245. The viewing angle of tablet support assembly 1210 can be adjusted to provide a comfortable viewing or operating position for a user of the tablet computing device. When in a viewing configuration, tablet computer lap stand case 1200 can thus allow a user to view the tablet computing device screen at various viewing angles.

In certain embodiments, when tablet computer lap stand case 1200 is used on a substantially flat surface in a viewing configuration, as shown in FIGS. 12 and 13, front cover first region 1280, front cover second region 1270, and spine 1260 can rest upon the surface and be substantially co-planar with the surface so as to provide a base for tablet computer lap stand case 1200. In various embodiments, when tablet computer lap stand case 1200 is used in a viewing configuration on a surface, back cover second region 1250 can be supported upon the flat surface along back edge of spine 1255, and back cover second region 1250 can form an acute angle with spine 1260, extending from one side to the other side of back edge of spine 1255. The sides of back edge of spine 1255 can form corners that rest upon the flat surface, which can advantageously provide secure support to prevent tablet computer lap stand case 1200 from tipping to one of the sides when used in an upright viewing configuration on a surface.

In certain embodiments, tablet case front cover 1232 can include one or more positioning magnets (not shown) that can be magnetically coupled to the one or more second edge magnets to physically secure tablet support assembly 1210 to tablet case front cover 1232. In some embodiments, the positioning magnets can be located just beneath the inner surface layer of front cover first region 1280. In other embodiments, tablet computer lap stand case 1200 does not include the second edge magnets or the positioning magnets. In various embodiments, second edge 1216 and/or the inner layer of tablet case front cover 1232 can be made of a non-slip material, such as grip suede, so as to provide sufficient surface friction to prevent tablet support assembly from slipping out of position in various viewing angles. In other embodiments, or in addition, the inner surface of tablet case front cover 1232 can include one or more slots, grooves, or indentations (e.g. 1281), and/or second edge 1216 can include one or more protrusions (not shown), and the protrusions can provide additional physical support to hold tablet support assembly 1210 in place on tablet case front cover 1232, such as by securing the protrusions in the slots. In further embodiments, the inner surface of tablet case front cover 1232 can include one or more protrusions (in addition to or instead of the slots, grooves, or indentations) for the same purpose.

FIG. 14 is a side view of tablet computer lap stand case 1200 in a viewing configuration on a user's leg. When tablet computer lap stand case 1200 is placed on a user's leg in a viewing configuration, tablet case front cover 1232 can bend at front cover hinge 1275 such that front cover second region 1280 rests along the top of the leg and is co-planar with the top of the leg, and front cover second region 1270 can extend downward from front cover hinge 1275. The two segments of spine 1260 surrounding shape forming region 1290, as well as portions of back cover second region 1250 and front cover 1270 surrounding shape forming region 1290 can extend below the plane of the top of the user's leg on each side of the user's leg. In some embodiments, when tablet computer lap stand case 1200 is placed on a user's leg, front cover edge 1294 and back cover edge 1295 can rest upon the top side of the user's leg. In certain embodiments, one or more layers of shape forming region 1290 can be between front cover edge 1294 and/or back cover edge 1295 and the user's leg. In a number of embodiments, first spine side edge 1293 can rest against the left side of the user's leg, and second spine side edge 1292 can rest against the right side of the user's leg, which can advantageously provide stable side supports to prevent tablet computer lap stand case 1200 from tipping to a side when used upon the user's leg.

In various embodiments, the weight of the tablet computing device can provide tablet computer lap stand case 1200 with sufficient downward force such that shape-forming region 1290 can conform to shape around the user's leg to provide a balanced support stand for viewing and/or operating the tablet computing device at various viewing angles. Shape-forming region 1290 thus can allow a user to comfortably and securely use the tablet computing device on the user's lap. In some embodiments, when tablet computer lap stand case 1200 is placed on a user's leg in a viewing configuration, the material used in shape-forming region 1290 can deform such that rounded edge 1291 can partially or fully rest upon the user's leg, such that the user's leg can support back cover second region 1250 along or near back cover edge 1295, and/or the user's leg can support front cover second region 1270 along or near front cover edge 1294. In some embodiments, the material used in shape-forming region 1290 can provide additional surface contact with the user's leg, in addition to or in place of rounded edge 1291, so as to provide additional balance and/or to prevent tablet computer lap stand case 1200 from tipping or slipping to a side of the user's leg. Additionally, the material used for the outer surface of tablet case front cover 1232 and the outer surface of shape forming region 1290 can be made of one or more high friction materials to further improve the stability of tablet computer lap stand case 1200 on the user's leg. Rounded edge 1291, back cover second region 1250, and/or front cover second region 1270 can provide a rigid or semi-rigid support such that back cover second region 1250 and/or front cover second region 1270 are each substantially planar and not deformed by the user's leg.

FIG. 15 is a front view of tablet computer lap stand case 1200 in a closed configuration. In various embodiments in the closed configuration, the inner surface of tablet case front cover 1232 can rest against and/or be positioned in close proximity to and substantially parallel to front side 1212 of tablet support assembly 1210. In the closed configuration, in some embodiments, first edge 1214 can rest against or be positioned in close proximity to third edge 1285, and second edge 1217 can rest against or be positioned in close proximity to the inner surface of spine 1260 and/or the portion of shape-forming region 1290 between the two portions of spine 1260. In certain embodiments in a closed configuration, first region 1213 of tablet support assembly 1210 can be in close proximity to front cover first region 1280, and second region 1215 of tablet support assembly 1210 can be in close proximity to and between back cover second region 1250 and front cover second region 1270. In some embodiments in the closed configuration, the third edge magnets can magnetically couple to the first edge magnets to secure tablet computer lap stand case 1200 in a closed configuration. In a number of embodiments, when tablet computer lap stand case 1200 is in a closed configuration, it can securely hold and partially or fully surround the tablet computing device, for example. A closed configuration can, in various embodiments, provide protection for the tablet computing device and its screen from damage.

FIG. 16 is a back right side perspective view showing various elements of tablet computer lap stand case 1200 in a typing configuration on a flat surface. In a typing configuration, in some embodiments, tablet case cover 1230 can be folded to form an triangular support to provide an elevated support for tablet support assembly 1210. Specifically, in a number of embodiments, tablet case cover 1230 can be folded such that back cover second region 1250 and spine 1260 can form a base support for the triangular support, front cover second region 1270 can form an elevated region for the triangular support, and front cover first region 1280 can form a top support for tablet support assembly 1210. In some embodiments, third edge 1285 can be located at back cover hinge 1245 between the inner side of back cover second region 1250 and back side 1211 of tablet support assembly 1210. When tablet computer lap stand case 1200 is in a typing configuration on a surface, in certain embodiments, tablet support assembly 1210 can be supported such that second region 1215 is higher than first region 1213, which is the opposite of the viewing configuration in FIGS. 12-14. Tablet computer lap stand case 1200 can rest upon the surface along front edge of spine 1265 and along first edge 1214. Back cover hinge 1245 can be elevated from the surface, and second edge 1216 can rest upon front cover first region 1280 near front cover hinge 1275.

Front side 1212 of tablet support assembly 1210 can be at the top of tablet computer lap stand case 1200 in a typing configuration, thus allowing a user to view, operate, and/or manipulate the touchscreen of the tablet computing device. When in a typing configuration, in some embodiments, tablet computer lap stand case 1200 can allow a user to view and/or operate the tablet computing device at a less upright angle than in a viewing configuration (as shown in FIGS. 12-14 and described above), which can advantageously provide an ergonomic typing configuration for the user. In various embodiments, when tablet computer lap stand case 1200 is used in a typing configuration on a surface, front cover second region 1270 can be supported upon the flat surface along front edge of spine 1265, and back cover second region 1250 and spine 1260 can form an acute angle or a right angle with first cover second region 1270, extending from one side to the other side of front edge of spine 1265. The sides of front edge of spine 1265 can form corners that can rest upon the flat surface, which can advantageously provide secure support to prevent tablet computer lap stand case 1200 from tipping to one of the sides when used in a typing configuration on a surface. In a number of embodiments, front edge of spine 1265 can, when placed on a surface, be located beyond second edge 1216 (and not beneath tablet support assembly 1210) such that front edge of spine 1265 can provide a secure back support base for tablet computer lap stand case 1200 when used in a typing configuration. Specifically, in some embodiments, when used in a typing configuration on a flat surface, and when tablet support assembly 1210 is securing the tablet computing device, tablet computer lap stand case 1200 will not tip when a user applies a significant perpendicular force at any point on the tablet computing device.

FIG. 17 is a back left side perspective view of tablet computer lap stand case 1200 in a typing configuration on a user's leg. When tablet computer lap stand case 1200 is placed on a user's leg in a typing configuration, tablet case cover 1230 can bend at back edge of spine 1255 and/or spine 1260 such that the two segments of spine 1260 surrounding shape forming region 1290 can extend downward from back edge of spine 1255. The two segments of spine 1260, and portions of back cover second region 1250 and front cover 1270 surrounding shape forming region 1290, can extend below the plane of the top of the user's leg on each side of the user's leg. In some embodiments, when tablet computer lap stand case 1200 is placed on a user's leg, front cover edge 1294 and back cover edge 1295 (FIGS. 12 and 14) can rest upon the top side of the user's leg. In certain embodiments, one or more layers of shape forming region 1290 can be between front cover edge 1294 and/or back cover edge 1295 and the user's leg. In a number of embodiments, first spine side edge 1293 (FIGS. 12-14) can rest against the right side of the user's leg, and second spine side edge 1292 (FIGS. 12-14) can rest against the left side of the user's leg, which can advantageously provide stable side supports to prevent tablet computer lap stand case 1200 from tipping to a side when used in a typing configuration upon the user's leg.

In various embodiments, as described above in the viewing configuration, the weight of the tablet computing device can provide tablet computer lap stand case 1200 with sufficient downward force such that shape-forming region 1290 can conform to shape around the user's leg to provide a balanced support stand for viewing and/or operating the tablet computing device in a typing configuration. Shape-forming region 1290 thus can allow a user to comfortably and securely use a tablet computing device on the user's lap, which can provide a comfortable and/or ergonomic typing configuration for the user. In some embodiments, when tablet computer lap stand case 1200 is placed on a user's leg in a viewing configuration, the material used in shape-forming region 1290 can deform such that rounded edge 1291 can partially or fully rest upon the user's leg, such that the user's leg can support back cover second region 1250 along or near back cover edge 1295 (FIGS. 12 and 14), and/or the user's leg can support front cover second region 1270 along or near front cover edge 1294. As described above, in some embodiments, the material used in shape-forming region 1290 can provide additional surface contact with the user's leg, in addition to or in place of rounded edge 1291, so as to provide additional balance and/or to prevent tablet computer lap stand case 1200 from tipping and/or slipping to a side of the user's leg when used in a typing configuration. Rounded edge 1291, back cover second region 1250, and/or front cover second region 1270 can provide a rigid or semi-rigid support such that back cover second region 1250 and/or front cover second region 1270 are each substantially planar and not deformed by the user's leg.

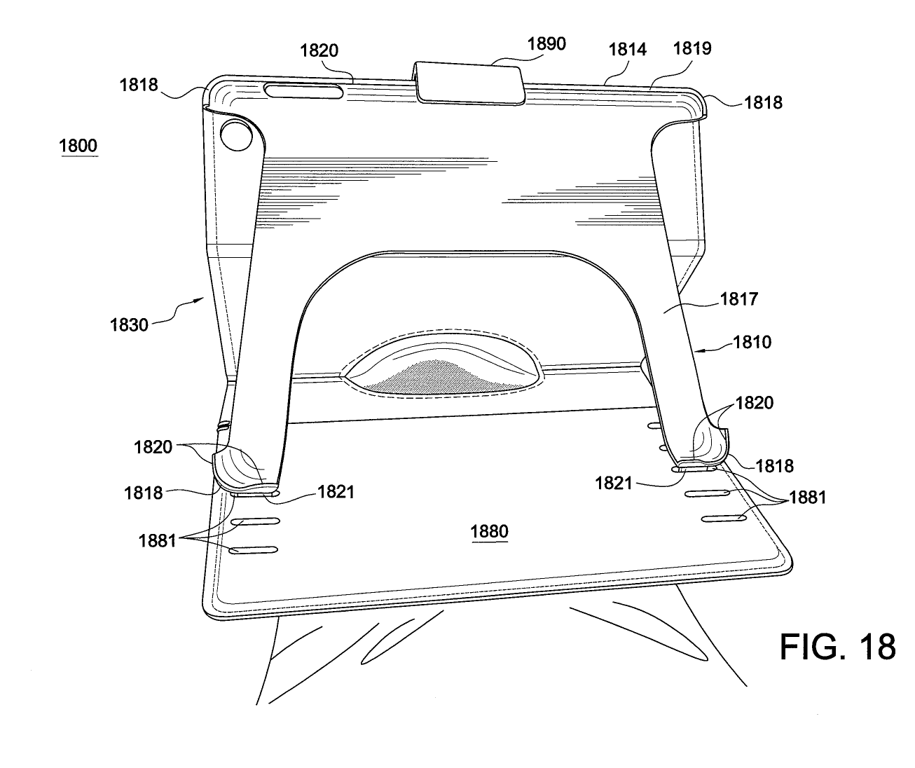

FIG. 18 is a front view of a tablet computer lap stand case 1800 in a viewing configuration on a user's leg. Tablet computer lap stand case 1800 can be similar to tablet computer lap stand case 1200 (FIG. 12), and various components and/or constructions of tablet computer lap stand case 1800 can be similar or identical to various components of tablet computer lap stand case 1200. Tablet computer lap stand case 1800 can include a tablet support assembly 1810 and a tablet case cover 1830. Tablet case cover 1830 can be similar to tablet case cover 1230 (FIG. 12). Tablet support assembly 1810 can be a frame that can include a frame back 1817, and one or more frame corners 1818 and/or frame edges 1819. Frame back 1817 can provide a back support for the tablet computing device. Frame corners 1818 and/or frame edges 1819 can extend outward from frame back 1817, and can include a lip 1820, which, in some embodiments, can wrap around the corners and/or edges of the tablet computing device sufficiently to receive and fittingly secure the tablet computing device in tablet support assembly 1810. Frame corners 1818 and frame edges 1819 can be connected, and, in some embodiments, can be molded as one piece. In certain embodiments, frame corners 1818, frame edges 1819, and frame back 1817 can all be molded as one piece. Tablet support assembly 1810 can be made of a suitable rigid polymer (e.g., polycarbonate (PC) or ABS), metal (e.g., aluminum), ceramic material, thermoplastic elastomer (TPE) (e.g., thermoplastic polyurethane (TPU)), and/or semi-rigid polymer.

As shown in FIG. 18, tablet case cover 1830 can include front cover first region 1880, which can be similar to front cover first region 1280 (FIG. 12). In a number of embodiments, Front cover first region 1880 can include one or more grooves 1881. In a different embodiment, front cover first region 1880 can include one or more protrusions in addition to or instead of one or more grooves 1881. Tablet support assembly 1810 can include one or more protrusions 1821, which can engage in the grooves to hold tablet support assembly 1810 in place on front cover first region 1880. Tablet computer lap stand case 1800 can include a flap 1890, which can be attached to a first edge 1814 and can extend around tablet support assembly 1810 and a portion of front cover first region 1880 when tablet computer lap stand case 1800 is in a closed configuration, similarly as shown in FIG. 15 and described above. In some embodiments, flap 1890 can include a magnet that can magnetically couple with a magnet in front cover first region 1880 to secure tablet computer lap stand case 1800 in a closed configuration. In other embodiments, flap 1890 can include one or more fasteners, such as hook-and-loop tape and/or one or more snaps, to secure flap 1890 in place and to secure tablet computer lap stand case 1800 in a closed configuration.

FIG. 19 is a top view a tablet computer lap stand case 1900 in a fully unfolded configuration. Tablet computer lap stand case 1900 can be similar to tablet computer lap stand case 1200 (FIG. 12) and tablet computer lap stand case 1800 (FIG. 18), and various components and/or constructions of tablet computer lap stand case 1900 can be similar or identical to various components of tablet computer lap stand case 1200 (FIG. 12) and tablet computer lap stand case 1800 (FIG. 18). Tablet computer lap stand case 1900 can include a tablet support assembly 1981 and a tablet case cover 1930. Tablet case cover 1930 can be similar to tablet case cover 1230 (FIG. 12) and tablet case cover 1830 (FIG. 18), and tablet support assembly 1981 can be similar to tablet support assembly 1810 (FIG. 18). Tablet case cover 1930 can include front cover first region 1980, which can be similar to front cover first region 1280 (FIG. 12) and front cover first region 1880 (FIG. 18). In a number of embodiments, front cover first region 1980 can include an elastic band 1990, which can extend across all of front cover first region 1980 and can be attached to the sides of front cover first region 1980. Elastic band 1990 can, in various embodiments, extend around tablet support assembly 1981 when tablet computer lap stand case 1900 is in a closed configuration (similarly as shown in FIG. 15 and described above), and can securely hold tablet computer lap stand case 1900 in a closed configuration. When tablet computer lap stand case 1900 is open, elastic band 1990 can rest across either the inner or outer surface of front cover first region 1980. Elastic band 1990 can be made of an elastic ribbon, which can be made of synthetic or natural rubber and a fabric.

Tablet computer lap stand case 1900 can also include a sleep magnet 1995. For example, sleep magnet 1995 can be located within front cover first region 1980 such that it when tablet computer lap stand case 1900 is in a closed configuration, sleep magnet 1995 is located in close proximity to a sleep/wake sensor in the tablet computing device. Various tablet computing devices, such as the iPad, can use the sleep/wake sensor to sense the proximity of sleep magnet 1995 and detect whether the tablet computing device is in a closed configuration (as shown in FIG. 15, described above), in which case the tablet computing device can put itself to sleep, including turning off its screen. If instead the sleep/wake sensor detects that the tablet computing device is in an open configuration, such as the viewing configuration (as shown in FIGS. 12-14, and 18, described above) or the typing configuration (as shown in FIG. 16-17, described above), tablet computing device can wake itself up, including turning on its screen.

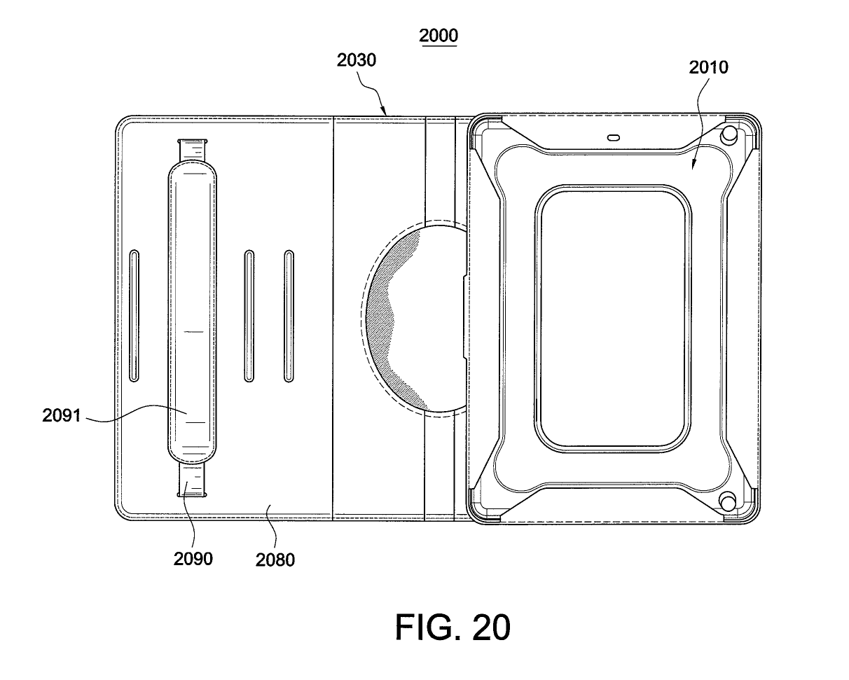

FIG. 20 is a top view a tablet computer lap stand case 2000 in a fully unfolded configuration. Tablet computer lap stand case 2000 can be similar to tablet computer lap stand case 1200 (FIG. 12), tablet computer lap stand case 1800 (FIG. 18), and tablet computer lap stand case 1900 (FIG. 19), and various components and/or constructions of tablet computer lap stand case 2000 can be similar or identical to various components of tablet computer lap stand case 1200 (FIG. 12), tablet computer lap stand case 1800 (FIG. 18), and tablet computer lap stand case 1900 (FIG. 19). Tablet computer lap stand case 2000 can include a tablet support assembly 2010 and a tablet case cover 2030. Tablet case cover 2030 can be similar to tablet case cover 1230 (FIG. 12), tablet case cover 1830 (FIG. 18), and tablet case cover 1930 (FIG. 19). Tablet support assembly 2010 can be similar to tablet support assembly 1810 (FIG. 18) and tablet support assembly 1981 (FIG. 19). Tablet case cover 2030 can include front cover first region 2080, which can be similar to front cover first region 1280 (FIG. 12), front cover first region 1880 (FIG. 18), and front cover first region 1980 (FIG. 19).

In a number of embodiments, front cover first region 2080 can include a hand strap 2090, which can extend partially across front cover first region 2080 and can be attached to the inner side of front cover first region 2080. In other embodiments, hand strap 2090 can be attached to the outer side of front cover first region 2080. Hand strap 2090 can be made of a suitable leather or fabric. In some embodiments hand strap 2090 can be made of an elastic ribbon, which can be made of synthetic or natural rubber and a fabric. In various embodiments, hand strap 990 can include a contact region 2091, which can be made of a soft and/or padded fabric, or another material suitable for extended contact with a hand. In certain embodiments, contact region can surround hand strap 2090, and can extend partially or fully along hand strap 2090, which can extend partially or fully across the inner side of front cover first region 2080. In certain embodiments, a user can hold hand strap 2090 while using tablet computer lap stand case 2000, such as in a viewing configuration (shown in FIGS. 12-14, described above). The user can hold hand strap 2090, for example, by placing the user's hand between hand strap 2090 (and/or contact region 2091) and front cover first region 2080, or by placing the hand around both sides of hand strap 2090 (and/or contact region 2091). In various embodiments, hand strap 2090 can allow the user to prevent portable computer lap stand case 2000 from slipping or being bumped off the user's lap, such as while the riding on a bus on a bumpy road. Hand strap 2090 can also be used, in various embodiments, to extend around tablet support assembly 2010 when tablet computer lap stand case 2000 is in a closed configuration (similarly as shown in FIG. 15 and described above) to securely hold tablet computer lap stand case 2000 in a closed configuration. In another application, front cover first region 2080 can be folded behind tablet support assembly 2010, and a user's hand can be placed between hand strap 2090 and front cover first region 2080 to hold tablet computer lap stand case 2000 while viewing and/or otherwise using the tablet computing device held by tablet support assembly 2010.

FIGS. 12 to 17 illustrate an example of an apparatus (e.g., case 1200) for supporting an electronic device, such as a tablet computer, from a user's leg. In this example, the apparatus includes a substantially planar base (e.g., front cover 1232), a substantially planar lower back member (e.g., back cover second region 1250), a first hinge (e.g., spine 1260) attaching (i.e., pivotably attaching) the lower back member to the base, an upper back member (e.g., back cover first region 1240), and a second hinge (e.g., 1245) attaching (i.e., pivotably attaching) the upper back member to the lower back member. As used herein, “substantially planar” means within the same plane, to within 0.75 inches in either direction from the plane. Further, as used herein, “planar”, without being preceded by the word “substantially”, means within the same plane, to within 0.375 inches, in either direction, from the plane. In some embodiments, one or more of the base, lower back member, or upper back member, are planar. Moreover, in some embodiments, the upper back member is substantially planar. Even further, in some embodiments, when the first hinge and the second hinge are unfolded so that the apparatus is laid flat (e.g., as shown for different embodiments in FIGS. 19 and 20), the apparatus is substantially planar. Further still, in particular embodiments, when the first hinge and the second hinge are unfolded so that the apparatus is laid flat (e.g., as shown in FIGS. 19 and 20), the apparatus is planar.

A number of embodiments include a leg-conforming region (e.g., shape-forming region 1290) having a rounded edge (e.g., 1291) configured to conform around the top of one of the user's legs. As used herein, an edge being “configured to conform around the top of one of the user's legs” means that the edge is shaped to follow the contour of a typical leg of a typical user. FIGS. 12 to 17 illustrate an example. Various embodiments include an arc, a circle or part of a circle, an ellipse or part of an ellipse, an oval or part of an oval, or a combination thereof, as examples. Other embodiments, however, may differ. Some embodiments, for example, include a leg-conforming region that does not follow the contour of a typical leg of a typical user.

In some embodiments, the base (e.g., front cover 1232) includes at least a first part (e.g., front cover edge 1294 shown in FIGS. 12, 14, and 17) of the rounded edge (e.g., 1291). Further, in some embodiments, the lower back member (e.g., back cover second region 1250) includes at least a second part (e.g., back cover edge 1295 shown in FIGS. 12 and 14) of the rounded edge (e.g., 1291). In some embodiments, the leg-conforming region (e.g., shape-forming region 1290) extends across the first hinge (e.g., spine 1260) from the base (e.g., front cover 1232) to the lower back member (e.g., back cover second region 1250).

In a number of embodiments, the apparatus includes a flexible top layer (e.g., 1301 shown in FIG. 13), a flexible bottom layer (e.g., 1303), and a stiffener layer or a stiff layer (e.g., 1302) located between the top layer and the bottom layer. In some embodiments, for example, the top layer and the bottom layer extend from the base to the upper back member through the lower back member, and the stiff layer is broken, for example, at the first hinge and at the second hinge to allow bending of the apparatus at the first hinge and at the second hinge. As used herein, a stiff layer is at least five times as stiff, in bending, as a flexible layer. In various embodiments, the stiff layer is at least 8, 10, 12, 15, or 20 times as stiff, in bending, as the flexible layer.

In FIG. 13, these layers are shown in the lower back member, but in some embodiments, similar or identical layers are present in the base and upper back member. In some embodiments, the stiff layer may be different (e.g., in thickness, material, or both) in the different members, for example, and may have differing stiffnesses. In particular embodiments, however, the same layers may be present throughout the apparatus (e.g., except at the hinges where the stiff layer may be omitted. In some embodiments, for example, the stiff layer (e.g., 1302 shown in FIG. 13) can be omitted from front edge 1265 to back edge 1255 of first hinge or spine 1260 as shown in FIGS. 12 and 15-17. In some embodiments, other hinges described herein are similar. Further, in some embodiments, other types of hinges may be used.

In various embodiments, the rounded edge (e.g., 1291) is formed within the stiff layer (e.g., 1302). This means that the stiff layer is cut or otherwise formed to form the desired shape of the rounded edge. In some embodiments, however, the top layer, the bottom layer, or both, are also cut or otherwise formed to conform to the rounded edge. For example, in some embodiments, the top layer and the bottom layer extend just past the stiff layer at the rounded edge and are sewn or otherwise attached to each other. In some embodiments, however, the top layer, the bottom layer, or both, cover the leg-conforming region, as other examples.

In some embodiments, the leg-conforming region includes a flexible material. Examples include cloth, leather, fabric, an elastomeric material, and foam. Neoprene is an example. In particular embodiments, the flexible material can include of the top layer, the bottom layer, or both, as other examples. In some embodiments, the leg-conforming region includes an elastic material, such as an elastomeric material or foam. Again, neoprene is an example. As used herein, an elastic material has a stiffness that is less than the stiffness of the top layer or the bottom layer. In some embodiments, however, the leg-conforming region includes a hole through the apparatus without any material. For example, in some embodiments, the top layer and the bottom layer extend just past the stiff layer at the rounded edge and are cut to conform to the rounded edge and are sewn or otherwise attached to each other.

In some embodiments, the leg-conforming region (e.g., shape-forming region 1290) includes a center (e.g., the center of a circle, oval, or ellipse, or equivalent) and the first hinge (e.g., spine 1260) extends through the center of the leg-conforming region. Examples are shown in FIGS. 19 and 20. As used herein, a hinge is considered to extend through a particular point (e.g., the center) if a line through the point of rotation of the hinge extends through the point, within a distance from the point of rotation to the stiff layer or, for example, from front edge 1265 to the point of rotation or from back edge 1255 to the point of rotation of the first hinge or spine 1260 as shown in FIGS. 12 and 15-17. Further, in some embodiments, the second hinge is parallel to the first hinge. As used herein, “parallel” (i.e., without being preceded by “substantially”) means within 10 degrees. Further still, as used herein, “substantially parallel” means within 20 degrees. Even further, in some embodiments, the second hinge is substantially parallel to the first hinge.

In a number of embodiments, the apparatus further includes a third hinge, for example, extending through the base. An example is front cover hinge 1275 shown in FIGS. 12-15 and 17. In some embodiments, the third hinge is substantially parallel to the first hinge, to the second hinge, or both. Further, in particular embodiments, the third hinge is parallel to the first hinge, to the second hinge, or both.

In some embodiments, without considering the leg-conforming region (e.g., shape-forming region 1290), the base (e.g., front cover 1232) is rectangular, the lower back member (e.g., back cover second region 1250) is rectangular, the upper back member is rectangular (e.g., back cover first region 1240), or a combination thereof, as examples. The embodiment illustrated in FIGS. 12-17 is an example. As used herein, “rectangular” means to within plus or minus ¼ inch, except that rounded, chamfered, or beveled corners are allowed, provided the amount of a side effected by any one corner is no more than ¼ of the length of any side. Further, in some embodiments, when the first hinge (e.g., spine 1260) and the second hinge (e.g., 1245) are unfolded so that the apparatus is laid flat (e.g., as shown in FIGS. 19 and 20), the apparatus is rectangular. In certain embodiments, when the first hinge and the second hinge are unfolded so that the apparatus is laid flat, the apparatus has rounded chamfered, or beveled corners. Further, in some embodiments, the apparatus includes a hand strap. An example is strap 2090 shown in FIG. 20 and described herein.

Another example of an embodiment is an apparatus for supporting an electronic device from a user's leg. In a number of embodiments, such an apparatus includes a flexible top layer (e.g., 1301 shown in FIG. 13), a flexible bottom layer (e.g., 1303), and a stiff layer (e.g., 1302) located between the top layer and the bottom layer. In various embodiments, the apparatus further includes at least one hinge (e.g., spine 1260), and the stiff layer is broken at the hinge to allow bending of the apparatus at the hinge. Further, in a number of embodiments, such an apparatus includes a leg-conforming region (e.g., shape-forming region 1290) having a rounded edge (e.g., 1291 shown in FIGS. 12-14) configured to conform around the top of the user's leg, wherein the rounded edge is formed within the stiff layer. Even further, in certain embodiments, the leg-conforming region extends across the hinge of the apparatus (e.g., from the base to the lower back member).

In addition to apparatuses, various methods are also contemplated concerning supporting an electronic device from a user's leg. An example is a method of obtaining, providing, or manufacturing an apparatus for supporting an electronic device from a user's leg. In this example, the method includes at least the acts of: obtaining, providing, or manufacturing a base (e.g., front cover 1232), obtaining, providing, or manufacturing a lower back member (e.g., back cover second region 1250), obtaining, providing, or manufacturing a first hinge (e.g., spine 1260) attaching the lower back member to the base, and obtaining, providing, or manufacturing a leg-conforming region (e.g., shape-forming region 1290) having a rounded edge (e.g., 1291 shown in FIGS. 12-14) configured to conform around the top of one of the user's legs, wherein the leg-conforming region extends across the first hinge from the base to the lower back member.

Although the invention has been described with reference to specific embodiments, it will be understood by those skilled in the art that various changes may be made without departing from the spirit or scope of the invention. For example, to one of ordinary skill in the art, it will be readily apparent portion 133 and portion 121 can include other complementary coupling mechanisms in addition to or instead of coupling mechanisms 355 and 356. Additional examples of such changes have been given in the foregoing description. Accordingly, the disclosure of embodiments of the invention is intended to be illustrative of the scope of the invention and is not intended to be limiting. It is intended that the scope of the invention shall be limited only to the extent required by the appended claims. To one of ordinary skill in the art, it will be readily apparent that the case and method of use discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment of the invention, and may disclose alternative embodiments of the invention.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. An apparatus for supporting a tablet computer from one of a user's legs, the one of the user's legs having a top, the apparatus comprising:
a substantially planar base;
a substantially planar lower back member;
a first hinge attaching the lower back member to the base;
an upper back member;
a second hinge attaching the upper back member to the lower back member; and
a leg-conforming region having a rounded edge configured to conform around the top of one of the user's legs.

2. The apparatus of claim 1 wherein the upper back member is substantially planar and wherein when the first hinge and the second hinge are unfolded so that the apparatus is laid flat, the apparatus is substantially planar.

3. The apparatus of claim 1 wherein the base comprises at least a first part of the rounded edge.

4. The apparatus of claim 1 wherein the lower back member comprises at least a second part of the rounded edge.

5. The apparatus of claim 1 wherein the leg-conforming region extends across the first hinge from the base to the lower back member.

6. The apparatus of claim 1, the apparatus comprising a flexible top layer, a flexible bottom layer, and a stiff layer located between the top layer and the bottom layer.

7. The apparatus of claim 6 wherein the top layer and the bottom layer extend from the base to the upper back member through the lower back member, and wherein the stiff layer is broken at the first hinge and at the second hinge to allow bending of the apparatus at the first hinge and at the second hinge.

8. The apparatus of claim 6 wherein the rounded edge is formed within the stiff layer.

9. The apparatus of claim 1 wherein the leg-conforming region comprises a flexible material.

10. The apparatus of claim 1 wherein the leg-conforming region comprises an elastic material.

11. The apparatus of claim 1 wherein the leg-conforming region comprises a hole through the apparatus without any material.

12. The apparatus of claim 1 wherein the leg-conforming region comprises a center and the first hinge extends through the center of the leg-conforming region.

13. The apparatus of claim 1 wherein the second hinge is parallel to the first hinge.

14. The apparatus of claim 1 further comprising a third hinge extending through the base, wherein the third hinge is substantially parallel to the first hinge and to the second hinge.

15. The apparatus of claim 1 wherein, without considering the leg-conforming region, the base is rectangular, the lower back member is rectangular, the upper back member is rectangular, and, when the first hinge and the second hinge are unfolded so that the apparatus is laid flat, the apparatus is rectangular.

16. The apparatus of claim 15 wherein, when the first hinge and the second hinge are unfolded so that the apparatus is laid flat, the apparatus has rounded corners.

17. The apparatus of claim 1 further comprising a hand strap.

18. An apparatus for supporting an electronic device from a user's leg, the apparatus comprising:
a flexible top layer;
a flexible bottom layer; and
a stiff layer located between the top layer and the bottom layer;
at least one hinge, wherein the stiff layer is broken at the hinge to allow bending of the apparatus at the hinge; and
a leg-conforming region having a rounded edge configured to conform around the top of the user's leg, wherein the rounded edge is formed within the stiff layer.

19. The apparatus of claim 18 wherein the leg-conforming region extends across the hinge of the apparatus.

20. An method of obtaining, providing, or manufacturing an apparatus for supporting an electronic device from a user's leg, the method comprising at least the acts of:
obtaining, providing, or manufacturing a base;
obtaining, providing, or manufacturing a lower back member;
obtaining, providing, or manufacturing a first hinge attaching the lower back member to the base; and
obtaining, providing, or manufacturing a leg-conforming region having a rounded edge configured to conform around the top of one of the user's legs, wherein the leg-conforming region extends across the first hinge from the base to the lower back member.
